(19) United States
(12) Patent Application Publication
(10) Pub. No.: US 2005/0125134 A1
(43) Pub. Date: Jun. 9, 2005

(54) Deceleration control apparatus and method for a vehicle

(75) Inventors: Kunhiro Iwatsuki, Toyota-shi (JP); Kazuyuki Shiiba, Susono-shi (JP); Hiroaki Fujinami, Susono-shi (JP); Masato Seki, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 10/999,136

(22) Filed: Nov. 30, 2004

(30) Foreign Application Priority Data
Dec. 5, 2003 (JP) 2003-407782

(51) Int. Cl. G06F 19/00

(52) U.S. Cl. 701/70; 701/54

(57) ABSTRACT

A deceleration control apparatus for a vehicle provided with a brake system for generating braking force in the vehicle, and a transmission, controls the brake system and the transmission such that a deceleration acting on the vehicle matches a target deceleration set as a deceleration to be applied to the vehicle by a brake operation of the brake system and a shift operation which shifts the transmission into a relatively low speed or speed ratio.

### INCORPORATION BY REFERENCE

The disclosure of Japanese Patent Application No. 2003-407782 filed on Dec. 5, 2003 including the specification, drawings and abstract is incorporated herein by reference in its entirety.

### BACKGROUND OF THE INVENTION

1. Field of the Invention

The invention relates to a deceleration control apparatus and method for a vehicle. More particularly, the invention relates to a deceleration control apparatus and method for a vehicle, which controls deceleration of the vehicle by an operation of a brake system which applies braking force to the vehicle and a shift operation that shifts an automatic transmission into a relatively lower speed or speed ratio.

2. Description of the Related Art

Technology is known that controls an automatic transmission and a brake in cooperation by operating the brake when the automatic transmission is manually shifted into a speed that will cause the engine brake to engage. One such example of this type of technology is disclosed in U.S. Pat. No. 2,503,426.

According to the technology disclosed in U.S. Pat. No. 2,503,426, when an automatic transmission (A/T) has been manually shifted so that the engine brake will engage, the brakes of the vehicle are operated to prevent free running of the vehicle due to the vehicle being in a neutral state between the time that the shift starts and the time that the engine brake engages.

According to U.S. Pat. No. 2,503,426, the brakes of the vehicle are operated corresponding to a peak value of an engine negative torque during the shift obtained from the type of shift and the vehicle speed and the like, from the time that a manual downshift command is given either for a predetermined period of time or until the engine brake starts to engage (i.e., until the absolute value of the negative torque of the output shaft of the automatic transmission becomes large). Because the brakes of the vehicle are applied during the manual shift with a braking force that corresponds to the negative torque of the output shaft of the automatic transmission during the shift, a braking force is applied to the vehicle which corresponds to the amount of engine brake during the manual shift. As a result, a steady braking force is applied to the vehicle from the time the manual shift is performed until the shift is complete, such that a highly responsive and steady braking force can be obtained during the manual shift. Fluctuation in braking force is able to be reduced because the engine brake does not suddenly engage due to the brakes of the vehicle being applied while the automatic transmission is in the neutral state.

In U.S. Pat. No. 2,503,426, the brake is operated a predetermined amount for a predetermined period of time to reduce (deceleration transitional characteristics) problems in the period of time until the deceleration torque by the manual downshift is stably generated. The problems with the deceleration transitional characteristics during a shift of the automatic transmission in U.S. Pat. No. 2,503,426 include the initial neutral state, and the low torque region and the torque step from the end of the first shift, at which time the second shift is performed, through the start of the second shift.

In the foregoing publication, the predetermined period of time for which the brakes are operated is determined based on the detection results of the rotation speed of the output shaft of the automatic transmission and the engine speed. The predetermined amount that the brakes are operated is determined based on the kind of shift and the vehicle speed. However, the following problems and complications arise when putting this method into practice.

That is, when the predetermined period of time is determined based on the detection results of the rotation speed of the output shaft of the automatic transmission and the like, detection delays, as well as a dispersion in those delays, may result in the deceleration torque produced by the brakes not matching the deceleration torque produced by the automatic transmission. As a result, good deceleration characteristics may not be achieved. Further, while it is possible to use a timer for timing the period of time that has passed from the shift timing (the start/end timing) when determining the predetermined period of time, dispersion in the shift timing may result in the deceleration torque produced by the brakes not matching the deceleration torque produced by the automatic transmission.

Also, with regard to the predetermined amount that the brakes are operated, dispersion (on both the release side and apply side) in the clutch torque of a clutch, which is an apply element of the automatic transmission, may also result in the deceleration torque produced by the brakes not matching the deceleration torque produced by the automatic transmission.

In order to solve the foregoing problems, a learning correction or other such measure based on the operating results of the automatic transmission and the brakes is necessary. The foregoing problem arises due to the fact that both the automatic transmission and the brakes are sequence controlled in the foregoing publication.

U.S. Pat. No. 2,503,426 only mentions that the brake control generates a braking force by the brakes for the predetermined period of time and of the predetermined amount during the period until the deceleration torque by the shift of the automatic transmission is stably generated. No mention was given to deceleration control required by various other situations.

As described above, the technology in U.S. Pat. No. 2,503,426 applies braking force by the brakes until the deceleration torque by the shift of the automatic transmission is stably generated. Accordingly, the braking force by the brakes is a value which is calculated only once for each shift as the predetermined amount based on the type of shift and the vehicle speed, and applied for a predetermined period of time. The amount of braking force applied by the brakes is fixed. Therefore, the technology in U.S. Pat. No. 2,503,426 does not anticipate flexibly controlling an event generated (by something other than a shift) in real time regarding a deceleration required by the vehicle by changing the braking force applied to the brakes.

Further, consideration given to the control details of the braking is insufficient. The technology described in U.S. Pat. No. 2,503,426 still leaves room for improvement with respect to deceleration transitional characteristics of the vehicle. Also, U.S. Pat. No. 2,503,426 only discloses deceleration control by a manual downshift and does not mention that the invention can be applied to deceleration control performed when it has been determined on the vehicle side that deceleration is necessary.

### SUMMARY OF THE INVENTION

In view of the foregoing problems, this invention thus provides a deceleration control apparatus and method for a vehicle which can respond to various situations and achieve a good deceleration transitional characteristic for the vehicle.

That is, one aspect of this invention relates to a deceleration control apparatus for a vehicle provided with a brake system for generating braking force in the vehicle, and a transmission. This deceleration control apparatus includes a controller that controls the brake system and the transmission such that a deceleration acting on the vehicle matches a target deceleration set as a deceleration to be applied to the vehicle by a brake operation of the brake system and a shift operation which shifts the transmission into a relatively low speed or speed ratio.

Another aspect of the invention relates to a deceleration control method for a vehicle provided with a brake system for generating braking force in the vehicle, and a transmission. This deceleration control method includes the steps of setting a target deceleration as a deceleration to be applied to the vehicle by a brake operation of the brake system and a shift operation which shifts the transmission into a relatively low speed or speed ratio; and controlling the brake system and the transmission so that the deceleration acting on the vehicle matches the set target deceleration.

According to the deceleration control apparatus and method for a vehicle described above, a target value of the deceleration, which is the sum of the deceleration by the brake system and the deceleration by the shift operation, can be set as the target deceleration. By cooperatively controlling the brake system and the transmission so that the deceleration matches the target deceleration, a smooth shift is made possible. Also, in the deceleration control according to the invention as described above, the operation of the brake system (i.e., brake control) and the shift operation (i.e., shift control) can be executed simultaneously in cooperation with one another. The deceleration here refers to the degree (amount) of vehicle deceleration represented by the deceleration or deceleration torque.

Still another aspect of the invention relates to a deceleration control apparatus for a vehicle provided with a brake system for generating braking force in the vehicle, and a transmission. This deceleration control apparatus includes a controller that controls the braking force generated by the brake system so that a target deceleration acts on the vehicle. This control is based on i) the target deceleration which is set as a deceleration to be applied to the vehicle by a brake operation of the brake system and a shift operation which shifts the transmission into a relatively low speed or speed ratio, and ii) a deceleration by the shift operation into a speed or speed ratio selected as a speed or speed ratio appropriate for achieving the target deceleration.

Yet another aspect of the invention relates to a deceleration control method for a vehicle provided with a brake system for generating braking force in the vehicle, and a transmission. This deceleration control method includes the steps of setting a target deceleration as a deceleration to be applied to the vehicle by a brake operation of the brake system and a shift operation which shifts the transmission into a relatively low speed or speed ratio; and controlling a braking force generated by the brake system so that the target deceleration acts on the vehicle. This control is based on the set target deceleration and a deceleration by the shift operation into a speed or speed ratio selected as a speed or speed ratio appropriate for achieving the target deceleration.

According to the deceleration control apparatus and method for a vehicle described above, when the target deceleration is set and the speed or speed ratio appropriate for achieving that target deceleration is selected, the brake system can be controlled in real time to compensate for the difference between the target deceleration and the deceleration by the shift into the selected speed or speed ratio so that, as an overall result of the cooperative control of the brake system and the transmission, the target deceleration acts on the vehicle.

Unlike the control in U.S. Pat. No. 2,503,426, the control of this invention is not a sequence control (e.g., a control in which the stages of the control are proceeded through successively according to a predetermined sequence in which, after the type of shift is determined, the braking force is then determined based on that type of shift and the vehicle speed, and then that determined braking force is applied for a predetermined period of time). Therefore, this invention is able to respond to various situations, and as a result, achieve a good deceleration transitional characteristic of the vehicle.

In this invention, as a result of the cooperative control, the brake system performs a final adjustment (correction control) when the target deceleration is applied to the vehicle. Because the brake system has better response as well as a higher degree of freedom in the deceleration it generates than does the transmission, it is suitable for executing the final adjustment when the target deceleration is applied to the vehicle as a result of cooperative control.

### BRIEF DESCRIPTION OF THE DRAWINGS

The above-mentioned objects, features, advantages, technical and industrial significance of this invention will be better understood by reading the following detailed description of exemplary embodiments of the invention, when considered in connection with the accompanying drawings, in which:

FIG. 1 is a flowchart illustrating a control by a deceleration control apparatus for a vehicle according to a first exemplary embodiment of the invention;

FIG. 2 is a block diagram schematically showing the deceleration control apparatus for a vehicle according to the first exemplary embodiment of the invention;

FIG. 3 is a skeleton view of an automatic transmission of the deceleration control apparatus for a vehicle according to the first exemplary embodiment of the invention;

FIG. 4 is a table showing engagement/disengagement combinations of the automatic transmission of the deceleration control apparatus for a vehicle according to the first exemplary embodiment of the invention;

FIG. 5 is a time chart showing the deceleration transitional characteristics of the deceleration control apparatus for a vehicle according to the first exemplary embodiment of the invention;

FIG. 6 is a view illustrating the gradient of the target deceleration of the deceleration control apparatus for a vehicle according to the first exemplary embodiment of the invention;

FIG. 7 is a view illustrating how the gradient of the target deceleration of the deceleration control apparatus for a vehicle is determined according to the first exemplary embodiment of the invention;

FIG. 8 is a block diagram schematically showing peripheral devices around a control circuit of a deceleration control apparatus for a vehicle according to a second exemplary embodiment of the invention;

FIGS. 9A and 9B are flowcharts illustrating control by the deceleration control apparatus for a vehicle according to the second exemplary embodiment of the invention;

FIG. 10 is time chart showing the deceleration transitional characteristics of the deceleration control apparatus for a vehicle according to the second exemplary embodiment of the invention;

FIG. 11 is a flowchart illustrating a control by a deceleration control apparatus for a vehicle according to a third exemplary embodiment of the invention;

FIG. 12 is a time chart showing the deceleration transitional characteristics of the deceleration control apparatus for a vehicle according to the third exemplary embodiment of the invention;

FIGS. 13A and 13B are flowcharts illustrating a control by a deceleration control apparatus for a vehicle according to a fourth exemplary embodiment of the invention;

FIGS. 14A and 14B are flowcharts illustrating a control by a deceleration control apparatus for a vehicle according to a fifth exemplary embodiment of the invention;

FIG. 15 is a time chart showing the deceleration transitional characteristics (a first case) of the deceleration control apparatus for a vehicle according to the fifth exemplary embodiment of the invention;

FIG. 16 is a time chart showing the deceleration transitional characteristics (a second case) of the deceleration control apparatus for a vehicle according to the fifth exemplary embodiment of the invention;

FIG. 17 is a graph showing the target deceleration (in the second case) of the deceleration control apparatus for a vehicle according to the fifth exemplary embodiment of the invention;

FIG. 18A is a flowchart illustrating a first part of an operation by a deceleration control apparatus for a vehicle according to a sixth exemplary embodiment of the invention;

FIG. 18B is a flowchart illustrating a second part of the operation by the deceleration control apparatus for a vehicle according to the sixth exemplary embodiment of the invention;

FIG. 19 is a block diagram schematically showing the deceleration control apparatus for a vehicle according to the sixth exemplary embodiment of the invention;

FIG. 20 is a target deceleration map of the deceleration control apparatus for a vehicle according to the sixth exemplary embodiment of the invention;

FIG. 21 is a speed target deceleration map of the deceleration control apparatus for a vehicle according to the sixth exemplary embodiment of the invention;

FIG. 22 is a chart showing a deceleration produced by an output shaft rotation speed and the speed in the deceleration control apparatus for a vehicle according to the sixth exemplary embodiment of the invention;

FIG. 23 is a graph showing the relationship between the speed target deceleration, the current gear speed deceleration, and the maximum target deceleration in the deceleration control apparatus for a vehicle according to the sixth exemplary embodiment of the invention;

FIG. 24 is a graph illustrating the deceleration for each vehicle speed in each gear speed in the deceleration control apparatus for a vehicle according to the sixth exemplary embodiment of the invention;

FIG. 25 is time chart illustrating the operation of the deceleration control apparatus for a vehicle according to the sixth exemplary embodiment of the invention;

FIG. 26A is a flowchart illustrating a first part of an operation by a deceleration control apparatus for a vehicle according to a seventh exemplary embodiment of the invention;

FIG. 26B is a flowchart illustrating a second part of the operation by the deceleration control apparatus for a vehicle according to the seventh exemplary embodiment of the invention;

FIG. 27 is a block diagram schematically showing a control circuit of a deceleration control apparatus for a vehicle according to an eighth exemplary embodiment of the invention;

FIG. 28 is a block diagram schematically showing a control circuit of a deceleration control apparatus for a vehicle according to a ninth exemplary embodiment of the invention;

FIG. 29 is a chart showing correction quantities for the deceleration for each corner size and output shaft rotation speed in the deceleration control apparatus for the vehicle according to the ninth exemplary embodiment of the invention; and

FIG. 30 is a chart showing correction quantities for the deceleration for each road ratio μ and output shaft rotation speed in a deceleration control apparatus for the vehicle according to a tenth exemplary embodiment of the invention.

### DETAILED DESCRIPTION OF THE PREFERRED EMBODIMENTS

In the following description and the accompanying drawings, the present invention will be described in more detail with reference to exemplary embodiments.

Hereinafter, ten embodiments according to the invention will be described. All ten embodiments relate to a deceleration control apparatus for a vehicle, which performs cooperative control of a brake system (including brakes and a motor/generator) and an automatic transmission. In addition, all ten embodiments have the following points in common.

That is, when a target value (a target deceleration) of a deceleration to be applied to the vehicle is set and a speed or speed ratio of the automatic transmission that is appropriate for achieving that target deceleration selected during cooperative control of the brake system and the automatic transmission, the brake system is controlled to compensate for the difference between the target deceleration and the deceleration produced by the shift into the selected speed or speed ratio so that, as an overall result of cooperative control of the brake system and the automatic transmission, the target deceleration acts on the vehicle.

In the exemplary embodiments of the invention, the brake system performs a final adjustment (correction control) when applying the target deceleration to the vehicle as a result of the cooperative control. The brake system has better response than the automatic transmission, which makes it suitable for performing the final adjustment when applying the target deceleration on the vehicle as the result of the cooperative control. That is, in the brake system, the time that it takes to generate a final steady-state value (i.e., the specific deceleration indicated in the control command) as an output, including wasted time and startup time and the like, for a command signal indicative of the specific deceleration to be produced by the brake system and the timing at which that deceleration is to be produced, as well as the time it takes until the output has stabilized at the final steady-state value, is short. Moreover, the difference between the size of the output and the final steady-state value, such as an overshoot, is small.

Also, compared with the automatic transmission, the brake system has a high degree of flexibility with respect to the deceleration generated, which means that the desired deceleration is able to be generated. As a result, the brake system is more suitable for performing the final adjustment when applying the target deceleration to the vehicle as a result of the cooperative control.

The target deceleration is not limited to being produced by only one of the brake system or the automatic transmission. On the contrary, it may be produced by both an operation of the brake system and a shift of the automatic transmission. That is, the target deceleration corresponds to the sum of the deceleration generated by an operation of the brake system and the deceleration generated a shift of the automatic transmission. In this case, the ratio of the deceleration generated by the operation of the brake system to the deceleration generated by the shift of the automatic transmission in the overall deceleration (i.e., the target deceleration) does not matter.

Here, the target deceleration is set as a joint target to be generated by control of both the brake system and the automatic transmission, as described above. This does not mean, however, that when a condition to end the control of one of either the brake system or the automatic transmission is satisfied, the deceleration to be achieved by the other of the brake system or the automatic transmission is excluded from the target deceleration as a result.

In the first and the fifth exemplary embodiments, when a manual downshift is performed, the target deceleration is set and the speed appropriate for achieving that target deceleration selected by the driver. A manual downshift in this case is a downshift that is performed manually when the driver wishes to increase the engine braking force.

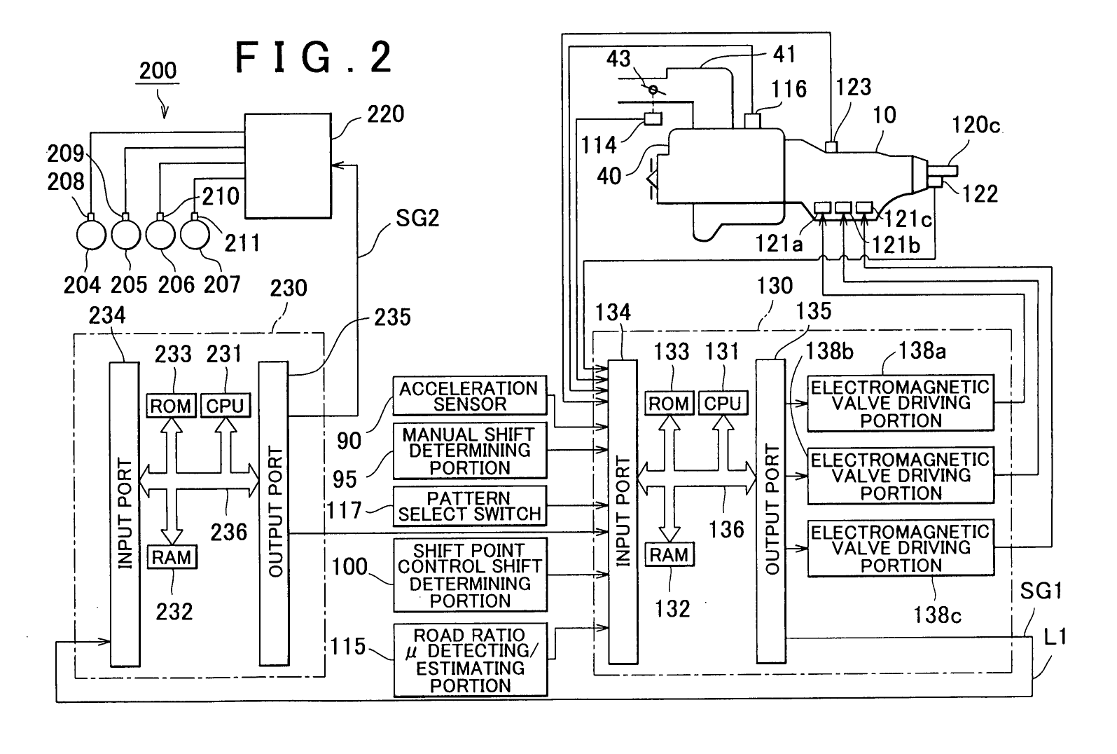

Also in the first to the fifth exemplary embodiments, when a shift by shift point control is performed, the target deceleration is set and the speed appropriate for achieving that target deceleration selected by a control circuit (reference numeral 130 in FIG. 2) mounted in the vehicle based on, for example, the size of a corner ahead of the vehicle or the road surface gradient. A shift by shift point control in this case is a shift that is performed based on various information such as information pertaining to the road on which the vehicle is running, including information about the size of an upcoming corner R and the road gradient, and road traffic information pertaining to traffic on the road on which the vehicle is running, including information about the distance between vehicles.

In the sixth to the tenth exemplary embodiments, when a shift by vehicle-to-vehicle distance control (vehicle-following control) is performed, the target deceleration is set and the speed appropriate for achieving that target deceleration selected by a control circuit (reference numeral 130 in FIG. 19) mounted in the vehicle based on the vehicle-to-vehicle distance, the relative vehicle speed, the time between vehicle, or the like.

With both shift point control and vehicle-to-vehicle distance control, the target deceleration is set and the speed appropriate for achieving that target deceleration selected automatically on the vehicle side according to the road and traffic conditions.

The target deceleration includes a deceleration gradient and a maximum target deceleration, to be described later. Also, the target deceleration can be updated in real time in response to, for example, a change in the size of an upcoming corner or the road surface gradient or the like, a change in the vehicle-to-vehicle distance, the relative vehicle speed, or the time between vehicles (which is calculated by dividing the object-to-vehicle distance by the vehicle speed), or the like, or a change in the engine braking force desired by the driver. That is, the target deceleration may be a value that is fixed until the foregoing control ends, or a value that varies.

When the deceleration is referred to in this specification, it is understood to be high when the absolute value of the deceleration is large and low when the absolute value of the deceleration is small.

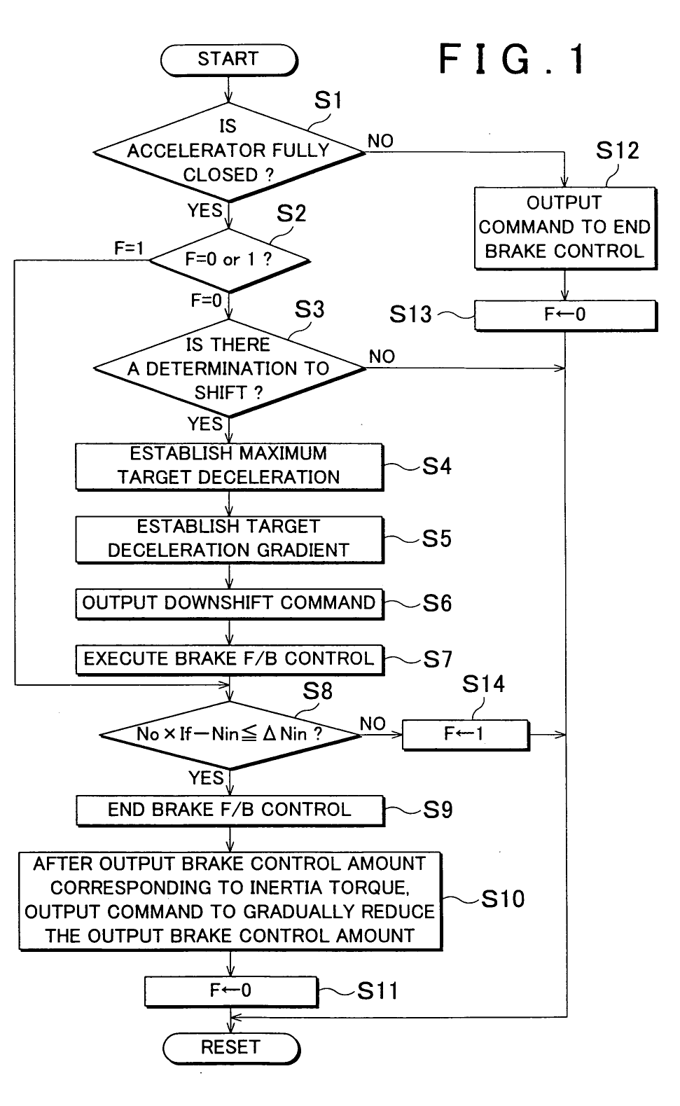

First, a first exemplary embodiment of the invention will be described with reference to FIGS. 1 to 7. This exemplary embodiment relates to a deceleration control apparatus for a vehicle, which performs a manual shift or a shift by shift point control by cooperative control of a brake system and an automatic transmission. The deceleration control apparatus for a vehicle according to this exemplary embodiment improves the deceleration transitional characteristics of the vehicle.

When the deceleration (braking force) is applied to the vehicle, it is possible that the vehicle may become unstable. U.S. Pat. No. 2,503,426 described above does not disclose technology for dealing with this. Another object of this exemplary embodiment is therefore to provide a deceleration control apparatus for a vehicle that can easily control a vehicle in an unstable state.

Also, shift point control technology has recently been developed that performs a shift based on the radius of an upcoming corner, the road gradient, and the like. As opposed to a manual shift, a shift by the shift point control has relatively little to do with an intention to shift of driver. This difference between a shift by shift point control and a manual shift must be taken into consideration when applying technology to cooperatively control the automatic transmission and brakes to a shift by shift point control. Still a further object of this exemplary embodiment is thus to provide a deceleration control apparatus for a vehicle that takes this difference into account.

According to this exemplary embodiment, in an apparatus for cooperatively controlling a brake system and an automatic transmission, when a manual downshift or a downshift by shift point control is performed, two target decelerations are set: one for an initial period (a first period) during which the target deceleration has at least a gradient, and another for a second period during which the target deceleration is generally level after the first period.

FIG. 2 shows an automatic transmission 10, an engine 40, and a brake system 200. The automatic transmission 10 is capable of achieving five speeds (1st speed to 5th speed) by controlling hydraulic pressure, which is done by energizing and de-energizing electromagnetic valves 121a, 121b, and 121c. FIG. 2 shows three electromagnetic valves 121a, 121b, and 121c, but their number is not limited to this. These electromagnetic valves 121a, 121b, and 121c are driven by signals sent from a control circuit 130.

A throttle opening amount sensor 114 detects an opening amount of a throttle valve 43 disposed inside an intake passage 41 of the engine 40. An engine speed sensor 116 detects the speed of the engine 40. A vehicle speed sensor 122 detects the rotational speed an output shaft 120c of the automatic transmission 10 in proportion to the vehicle speed. A shift position sensor 123 detects a shift position of the automatic transmission 10. A pattern select switch 117 is used when selecting a shift pattern of the automatic transmission 10.

An acceleration sensor 90 detects a deceleration of the vehicle. A manual shift determining portion 95 outputs a signal indicative of a need for a downshift (a manual downshift) or an upshift by a manual operation performed by the driver. A shift point control shift determining portion 100 outputs a signal indicative of a need for a downshift by shift point control. A road ratio μ detecting/estimating portion 115 detects or estimates a friction coefficient of the road surface (hereinafter referred to as “road ratio”) μ.

The signals indicative of the various detection results from the throttle opening amount sensor 114, the engine speed sensor 116, the vehicle speed sensor 122, the shift position-sensor 123, and the acceleration sensor 90 are all input to the control circuit 130. Also input to the control circuit 130 are a signal indicative of the switching state of the pattern select switch 117, a signal indicative of the detection or estimation results from the road ratio μ detecting/estimating portion 115, a signal indicative of the need to shift from the manual shift determining portion 95, and a signal indicative of the need to shift from the shift point control shift determining portion 100.

The control circuit 130 is a known micro-computer, and includes a CPU 131, RAM 132, ROM 133, an input port 134, an output port 135, and a common bus 136. Signals from the various sensors 114, 116, 122, 123, and 90, as well as signals from the pattern select switch 117, the road ratio μ detecting/estimating portion 115, the manual shift determining portion 95 and the shift point control shift determining portion 100 are all input to the input port 134. Electromagnetic valve driving portions 138a, 138b, and 138c, as well as a brake braking force signal line L1 leading to a brake control circuit 230 are all connected to the output port 135. The brake braking force signal line L1 transmits a brake braking force signal SG1.

An operation (a control step) illustrated in the flowchart in FIG. 1, in addition to a shift map for shifting the speed of the automatic transmission 10 and an operation for shift control (not shown), are stored in the ROM 133 in advance. The control circuit 130 shifts the automatic transmission 10 based on the various control conditions that are input.

The brake system 200 is controlled by the brake control circuit 230, into which the brake braking force signal SG1 is input from the control circuit 130, so as to brake the vehicle. The brake system 200 includes a hydraulic pressure control circuit 220 and brake devices 208, 209, 210, and 211 provided on vehicle wheels 204, 205, 206, and 207, respectively. Each brake device 208, 209, 210, and 211 controls the braking force of the corresponding wheel 204, 205, 206, and 207 according to a brake hydraulic pressure which is controlled by the hydraulic pressure control circuit 220. The hydraulic pressure control circuit 220 is controlled by the brake control circuit 230.

The hydraulic pressure control circuit 220 performs brake control by controlling the brake hydraulic pressure supplied to each brake device 208, 209, 210, and 211 based on a brake control signal SG2 that ultimately determines the braking force to be applied to the vehicle. The brake control signal SG2 is generated by the brake control circuit 230 based on the brake braking force signal SG1 that the brake control circuit 230 receives from the control circuit 130 of the automatic transmission 10.

The brake control circuit 230 is a known micro-computer, and includes a CPU 231, RAM 232, ROM 233, an input port 234, an output port 235, and a common bus 236. The hydraulic pressure control circuit 220 is connected to the output port 235. The operation for generating the brake control signal SG2 based on the various data included in the brake braking force signal SG1 is stored in the ROM 233 in advance. The brake control circuit 230 controls the brake system 200 (i.e., performs brake control) based on the various control conditions that are input.

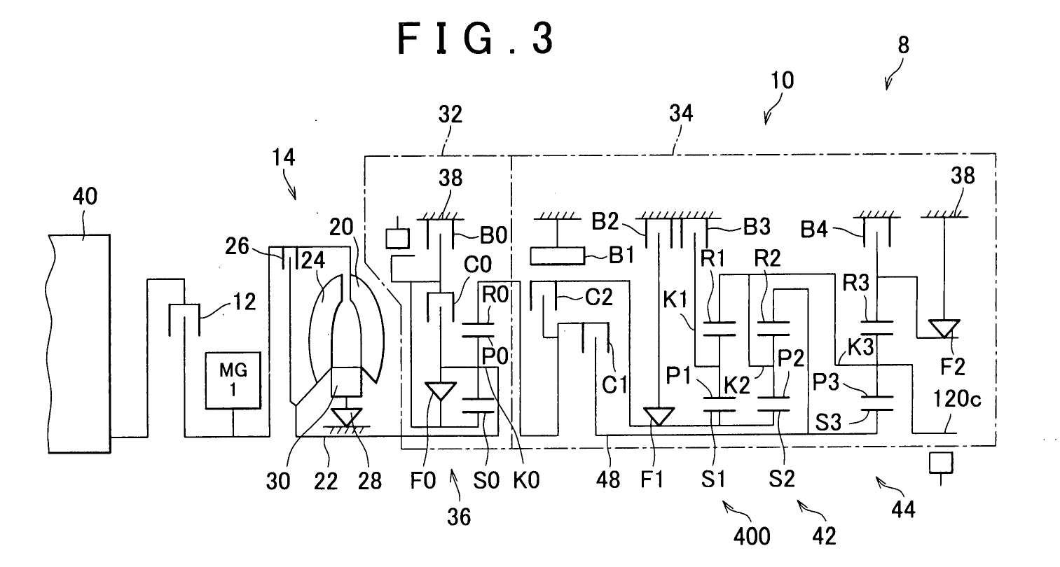

The structure of the automatic transmission 10 is shown in FIG. 3. In the drawing, output from the engine 40, i.e., an internal combustion engine which serves as the driving source for running the vehicle, is input to the automatic transmission 10 via an input clutch 12 and a torque converter 14, which is a hydraulic power transmitting device, and transmitted to driven wheels via a differential gear unit and an axle, not shown. A first motor/generator MG1 which functions as both an electric motor and a generator is arranged between the input clutch 12 and the torque converter 14.

The torque converter 14 includes a pump impeller 20 which is coupled to the input clutch 12, a turbine runner 24 which is coupled to an input shaft 22 of the automatic transmission 10, a lock-up clutch 26 for locking the pump impeller 20 and the turbine runner 24 together, and a stator 30 that is prevented from rotating in one direction by a one-way clutch 28.

The automatic transmission 10 includes a first transmitting portion 32 which switches between a high speed and a low speed, and a second transmitting portion 34 which is capable of switching between a reverse speed and four forward speeds. The first transmitting portion 32 includes an HL planetary gearset 36, a clutch C0, a one-way clutch F0, and a brake B0. The HL planetary gearset 36 includes a sun gear S0, a ring gear R0, and planetary gears P0 that are rotatably supported by a carrier K0 and in mesh with the sun gear S0 and the ring gear R0. The clutch C0 and the one-way clutch F0 are provided between the sun gear S0 and the carrier K0, and the brake B0 is provided between the sun gear S0 and a housing 38.

The second transmitting portion 34 includes a first planetary gearset 400, a second planetary gearset 42, and a third second planetary gearset 44. The first planetary gearset 400 includes a sun gear S1, a ring gear R1, and planetary gears P1 that are rotatably supported by a carrier K1 and in mesh with the sun gear S1 and the ring gear R1. The second planetary gearset 42 includes a sun gear S2, a ring gear R2, and planetary gears P2 that are rotatably supported by a carrier K2 and in mesh with the sun gear S2 and the ring gear R2. The third planetary gearset 44 includes a sun gear S3, a ring gear R3, and planetary gears P3 that are rotatably supported by a carrier K3 and in mesh with the sun gear S3 and the ring gear R3.

The sun gear S1 and the sun gear S2 are integrally coupled together, while the ring gear R1 and the carrier K2 and the carrier K3 are integrally coupled together. The carrier K3 is coupled to the output shaft 120c. Similarly, the ring gear R2 is integrally coupled to the sun gear S3 and an intermediate shaft 48. A clutch C1 is provided between the ring gear R0 and the intermediate shaft 48, and a clutch C2 is provided between the sun gear S1 and the sun gear S2, and the ring gear R0. Also, a band brake B1 is provided on the housing 38 in order to prevent the sun gear S1 and the sun gear S2 from rotating. Further, a one-way clutch F1 and a brake B2 are provided in series between the sun gear S1 and the sun gear S2, and the housing 38. The one-way clutch F1 applies when the sun gear S1 and the sun gear S2 try to rotate in the direction opposite that of the input shaft 22.

A brake B3 is provided between the carrier K1 and the housing 38, and a brake B4 and a one-way clutch F2 are provided in parallel between the ring gear R3 and the housing 38. The one-way clutch F2 applies when the ring gear R3 tries to rotate in the direction opposite that of the input shaft 22.

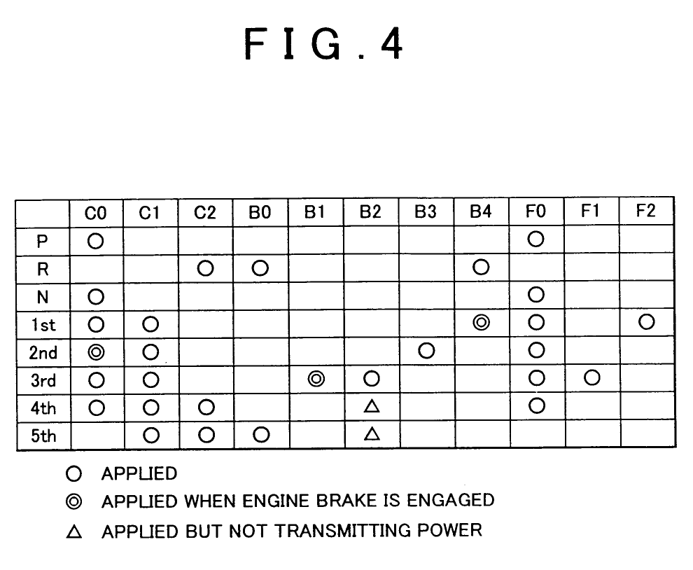

The automatic transmission 10 of the above-described structure is able to switch between any of one reverse speed and five forward speeds (1st to 5th) of different speed ratios, according to the table showing engagement/disengagement combinations of the automatic transmission shown in FIG. 4, for example. In the table in FIG. 4, the single circle indicates application, a blank space indicates release, a double circle (bulls-eye) indicates application when the engine brake is engaged, and a triangle indicates application but with no power being transmitted. The clutches C0 to C2 and the brakes B0 to B4 are all hydraulic friction apply devices that are applied by hydraulic actuators.

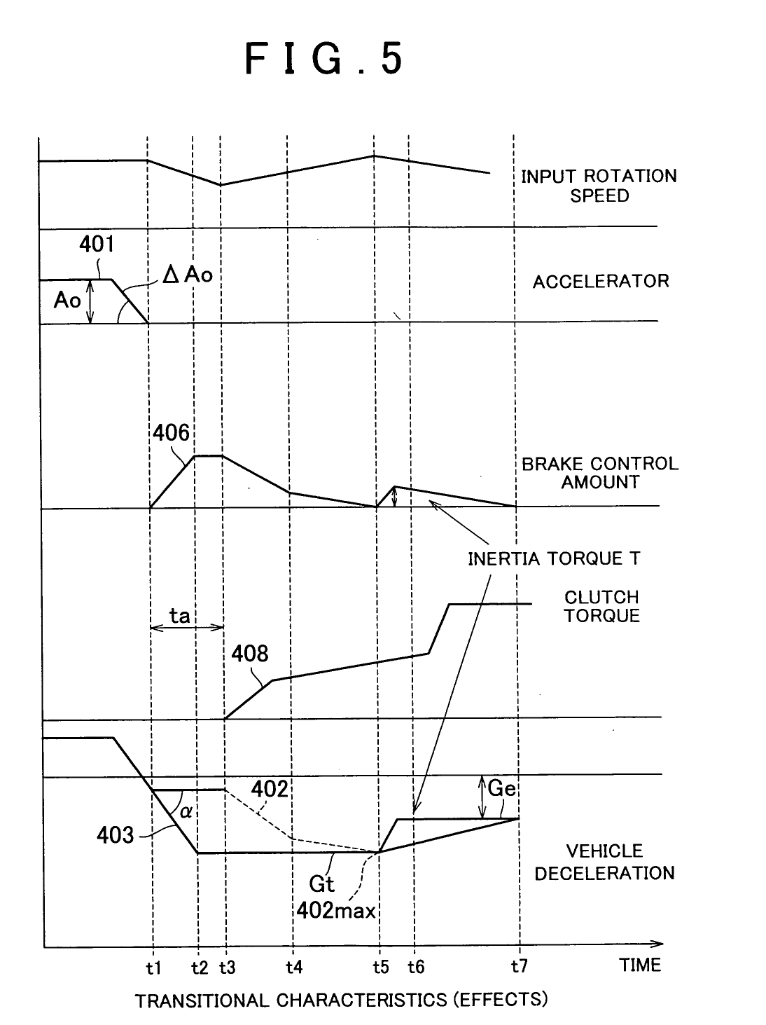

Next, operation of the first exemplary embodiment will be described with reference to FIGS. 1 and 5.

FIG. 1 is a flowchart showing the control flow of the first exemplary embodiment. FIG. 5 is a time chart to help explain the exemplary embodiment. The input rotation speed of the automatic transmission 10, accelerator opening amount, brake control amount, clutch torque, and deceleration (G) acting on the vehicle are all indicated in the drawing.

In FIG. 1, it is determined by the control circuit 130 in step S1 whether the accelerator (i.e., the throttle opening amount) is fully closed based on the detection results of the throttle opening amount sensor 114. If the accelerator is fully closed (i.e., YES in step S1), it is determined, when there is a shift, that the shift is intended to engage the engine brake. Therefore, the brake control of the exemplary embodiment is continued in steps S2 onward. In FIG. 5, the accelerator opening amount is fully closed at time t1, as denoted by reference numeral 401.

If, on the other hand, it is determined in step S1 that the accelerator is not fully closed (i.e., NO in step S1), a command is output to end the brake control of the exemplary embodiment (step S12). When the brake control is not being executed, this state is maintained. Next in step S13, a flag F is reset to 0, after which the control flow is reset.

In step S2, the flag F is checked by the control circuit 130. Because the flag F is 0 at the start of this control flow, step S3 is executed. If the flag F were 1, however, step S8 would be executed instead.

In step S3, it is determined by the control circuit 130 whether there is a determination to shift (i.e., whether there is a shift command). More specifically, it is determined whether a signal indicative of a need to shift the automatic transmission 10 into a relatively lower speed (i.e., a downshift) has been output from either the manual shift determining portion 95 or the shift point control shift determining portion 100. Data indicative of the speed into which the transmission is to be downshifted (hereinafter also referred to as the “target downshift speed”) is included in that signal.

When a signal indicative of a need to downshift is output from the manual shift determining portion 95, it means that the driver has set the deceleration obtained by a manual downshift into the target downshift speed that is specified by that signal as the “target deceleration” which is set as the joint target for the brake system 200 and the automatic transmission 10. It also means that, in this case, the driver has set the speed into target downshift speed specified by that signal as the “speed appropriate for achieving the target deceleration.”

When a signal indicative of the need to downshift is output from the shift point control shift determining portion 100, it means that the shift point control shift determining portion 100 has set the deceleration to be achieved by the downshift into the target downshift speed specified by that signal as the aforementioned “target deceleration” to be set as the joint target of the brake system 200 and the automatic transmission 10, as described above. In this case it also means that the shift point control shift determining portion 100 has set the target downshift speed specified by that signal as the “speed appropriate for achieving the target deceleration.”

In FIG. 5, the determination in step S3 is made at time t1. If it is determined in step S3 that a signal indicative of the need to downshift has been output from either the manual shift determining portion 95 or the shift point control shift determining portion 100 (i.e., YES in step S3), then step S4 is executed. If not (i.e., NO in step S3), the control flow is reset.

In the example described above, the accelerator is fully closed in step S1 at time t1, but it can be closed earlier, as long as it is closed before step S3 is performed at time t1. In regard to the signal indicating a need for a downshift output from the manual shift determining portion 95 or the shift point control shift determining portion 100, the example in FIG. 5 shows a case in which it has been determined by the control circuit 130 that there is a need for a downshift at time t1. Based on the determination that there is a need to downshift at time t1, the control circuit 130 then outputs a downshift command at time t1 (step S6), as will be described later.

In step S4, a maximum target deceleration Gt is obtained by the control circuit 130. The maximum target deceleration Gt is included in the “target deceleration” as the joint target for the brake system 200 and the automatic transmission 10 described above. This maximum target deceleration Gt is made the same (or approximately the same) as a maximum deceleration (to be described later) that is determined by the type of shift (e.g., by the combination of the speed before the shift and the speed after the shift, such as 4th→3rd or 3rd→2nd) and the vehicle speed. The broken line denoted by reference numeral 402 in FIG. 5 indicates the deceleration corresponding to the negative torque (braking force, engine brake) of the output shaft 120c of the automatic transmission 10, and is determined by the type of shift and the vehicle speed.

The maximum target deceleration Gt is determined to be substantially the same as a maximum value (the maximum deceleration mentioned above) 402max of a deceleration 402 that acts on the vehicle from the shift of the automatic transmission 10. The maximum value 402max of the deceleration 402 from the shift of the automatic transmission 10 is determined referencing a maximum deceleration map stored in advance in the ROM 133. In the maximum deceleration map, the value of the maximum deceleration 402max is determined based on the type of shift and the vehicle speed. After step S4, step S5 is then executed.

In step S5, a gradient α of a target deceleration 403 is determined by the control circuit 130. The target deceleration 403 (including the gradient α) is included in the aforementioned “target deceleration” that is set as the joint target for the brake system 200 and the automatic transmission 10.

When determining this gradient α, an initial gradient minimum value of the target deceleration 403 is first determined based on a time ta from after the downshift command is output (at time t1 in step S6, to be described later) until the shift (actually) starts (time t3), such that the deceleration that actually acts on the vehicle (hereinafter, this deceleration will be referred to as the “actual deceleration of the vehicle”) will reach the maximum target deceleration Gt by time t3 when the shift starts. The time ta from time t1 when the downshift command is output until time t3 when the shift actually starts is determined based on the type of shift.

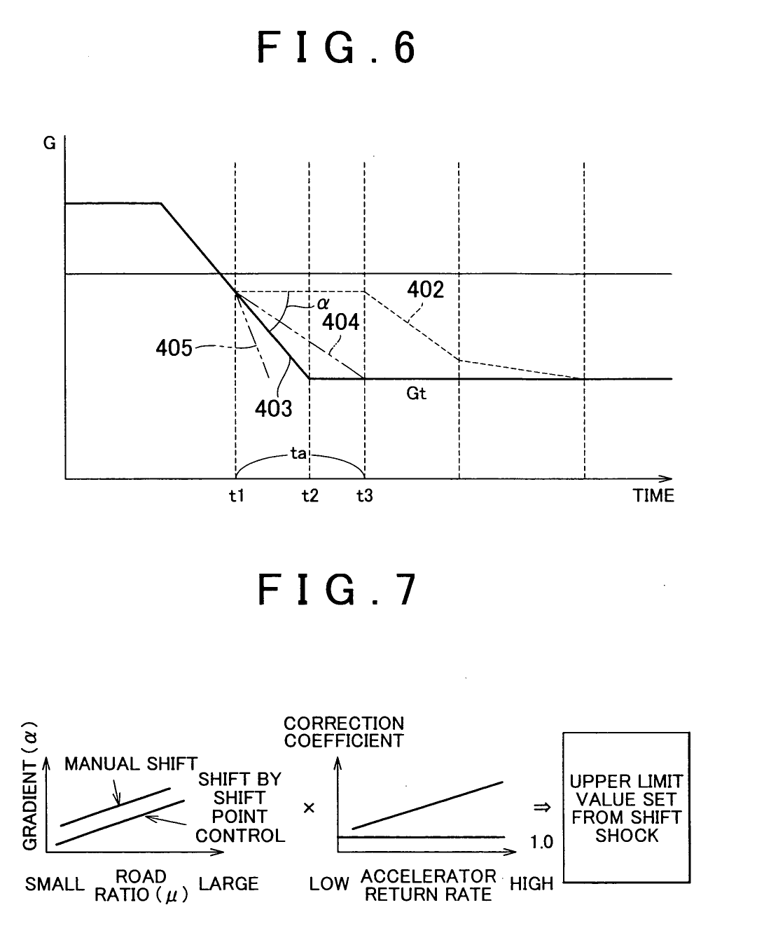

In FIG. 6, the chain double-dashed line denoted by reference numeral 404 corresponds to the initial gradient minimum value of the target deceleration. Also, a gradient upper limit value and a gradient lower limit value are set beforehand for the deceleration 403 such that shock accompanying deceleration does not become large and an instability phenomenon of the vehicle is able to be controlled (i.e., avoided). The chain double-dashed line denoted by reference numeral 405 in FIG. 6 corresponds to the gradient upper limit value.

An instability phenomenon of the vehicle refers to an unstable state of the vehicle, such as unstable behavior of the vehicle, a decrease in the degree of grip of the tires, or sliding that occurs for one reason or another such as a change in the road ratio μ or a steering operation when a deceleration (caused by brake control and/or the engine brake engaging due to a shift) acts on the vehicle.

In step S5, the gradient α of the target deceleration 403 is set larger than the gradient minimum value 404 but smaller than the gradient upper limit value 405, as shown in FIG. 6.

The initial gradient α of the target deceleration 403 sets the optimum manner of change for the deceleration in order to change the initial deceleration of the vehicle smoothly and prevent an instability phenomenon of the vehicle. The gradient α can be determined based on, for example, the rate at which the accelerator returned (hereinafter referred to as “accelerator return rate”) (see ΔΔo in FIG. 5) or the road ratio μ detected or estimated by the road ratio μ detecting/estimating portion 115. The gradient α can also be changed depending on whether the shift is a manual shift or a shift performed by shift point control. A detailed description of these is as follows with reference to FIG. 7.

FIG. 7 shows one example of a method for setting the gradient α. As shown in the drawing, the gradient α is set smaller the smaller the road ratio μ and larger the larger the accelerator return rate. Also, the gradient α is set smaller for a shift by shift point control than it is for a manual shift. This is because a shift by shift point control is not based directly on the intention of the driver so the rate of deceleration is set to be gradual (the deceleration is set relatively low). In FIG. 7, the relationships between the gradient α and the road ratio μ and the accelerator return rate and the like are linear, but they can also be set to be nonlinear.

A large portion (shown by the bold line in FIG. 5) of the target deceleration 403 in this exemplary embodiment is determined by steps S4 and S5. That is, as shown in FIG. 5, the target deceleration 403 is set to reach the maximum target deceleration Gt at the gradient α obtained in steps S4 and S5. Thereafter, the target deceleration 403 is maintained at the maximum target deceleration Gt until time t5 when the shift of the automatic transmission 10 ends. This is done in order to achieve a deceleration until the maximum deceleration 402max (≈maximum target deceleration Gt) produced by the shift of the automatic transmission 10 is reached, using the brakes, which have good response, while quickly suppressing deceleration shock. Realizing the initial deceleration with the brakes which have good response makes it possible to quickly control an instability phenomenon of the vehicle, should one occur. The setting of the target deceleration 403 after time t5 when the shift of the automatic transmission 10 ends will be described later. After step S5, step S6 is executed.

In step S6, the downshift command (shift command) is output from the CPU 131 of the control circuit 130 to the electromagnetic valve driving portions 138a to 138c. In response to this downshift command, the electromagnetic valve driving portions 138a to 138c energize or de-energize the electromagnetic valves 121a to 121c. As a result, the shift (i.e., the “shift into the speed appropriate for achieving the target deceleration”) indicated by the downshift command is executed in the automatic transmission 10. If it is determined by the control circuit 130 at time t1 that there is a need for a downshift (i.e., YES in step S3), the downshift command is output at the same time as that determination (i.e., at time t1).

As shown in FIG. 5, when a downshift command is output at time t1 (step S6), the shift of the automatic transmission 10 actually starts at time t3, after the time ta determined based on the type of shift has passed after time t1. When the shift starts, clutch torque 408 starts to increase, as does the deceleration 402 from the shift of the automatic transmission 10. After step S6, step S7 is executed.

In step S7, a brake feedback control is executed by the brake control circuit 230. As shown by reference numeral 406, the brake feedback control starts at time t1 when the downshift command is output.

That is, a signal indicative of the target deceleration 403 is output as the brake braking force signal SG1 at time t1 from the control circuit 130 to the brake control circuit 230 via the brake braking force signal line L1. Then based on the brake braking force signal SG1 input from the control circuit 130, the brake control circuit 230 then generates the brake control signal SG2 and outputs it to the hydraulic pressure control circuit 220.

The hydraulic pressure control circuit 220 then generates a braking force (a brake control amount 406) as indicated by the brake control signal SG2 by controlling the hydraulic pressure supplied to the brake devices 208, 209, 210, and 211 based on the brake control signal SG2.

In the feedback control of the brake system 200 in step S7, the target value is the target deceleration 403, the control amount is the actual deceleration of the vehicle, the objects to be controlled are the brakes (brake devices 208, 209, 210, and 211), the operating amount is the brake control amount 406, and the disturbance is mainly the deceleration 402 caused by the shift of the automatic transmission 10. The actual deceleration of the vehicle is detected by the acceleration sensor 90.

That is, in the brake system 200, the brake braking force (i.e., brake control amount 406) is controlled so that the actual deceleration of the vehicle comes to match the target deceleration 403. That is, the brake control amount 406 is set to produce a deceleration that makes up for the difference between the deceleration 402 caused by the shift of the automatic transmission 10 and the target deceleration 403 in the vehicle.

In the example shown in FIG. 5, the deceleration 402 caused by the automatic transmission 10 is zero from time t1 when the downshift command is output until time t3 when the automatic transmission actually starts to shift. Therefore, the brake control amount 406 is set such that the deceleration matches the entire target deceleration 403 using the brakes. From time t3 the automatic transmission 10 starts to shift, and the brake control amount 406 decreases as the deceleration 402 caused by the automatic transmission 10 increases.

In this way, the brake system 200 in this exemplary embodiment is feedback controlled to compensate for the difference between the target deceleration (403) and the deceleration by the shift into a speed that is appropriate for achieving the target deceleration (403) (i.e., the target downshift speed corresponding to the downshift command) so that, as an overall result of the cooperative control of the brake system 200 and the automatic transmission 10, the target deceleration (403) acts on the vehicle.

In step S8, the control circuit 130 determines whether the shift of the automatic transmission 10 is ending (or close thereto). This determination is made based on the rotation speed of rotating members in the automatic transmission 10 (see input rotation speed in FIG. 5). In this case, it is determined according to whether the following relational expression is satisfied.
No×If−Nin≦Nin

Here, No is the rotation speed of the output shaft 120c of the automatic transmission 10, Nin is the input shaft rotation speed (turbine rotation speed etc.), If is the speed ratio after the shift, and ΔNin is a constant value. The control circuit 130 inputs the detection results from a detecting portion (not shown) that detects the input shaft rotation speed Nin of the automatic transmission 10 (i.e., the turbine rotation speed of the turbine runner 24, etc.).

If that relational expression is not satisfied in step S8, it is determined that the shift of the automatic transmission 10 is not yet ending and the flag F is set to 1 in step S14, after which the control flow is reset. The routine then repeats steps S1, S2, and S8 until that relational expression is satisfied. If during that time the accelerator opening amount is anything other than fully closed, the routine proceeds to step S12 and the brake control according to this exemplary embodiment ends.

If, on the other hand, the foregoing relational expression in step S8 is satisfied, the routine proceeds on to step S9. In FIG. 5, the shift ends at (right before) time t5, whereby the relational expression is satisfied. As can be seen in FIG. 5, the deceleration 402 that acts on the vehicle from the shift of the automatic transmission 10 reaches the maximum value 402max (≈maximum target deceleration Gt) at time t5, indicating that the shift of the automatic transmission 10 has ended.

In step S9, the brake feedback control that started in step S7 ends. After step S9, the control circuit 130 no longer includes the signal corresponding to the brake feedback control in the brake braking force signal SG1 that is output to the brake control circuit 230.

That is, the brake feedback control is performed until the shift of the automatic transmission 10 ends. As shown in FIG. 5, the brake control amount 406 is zero at time t5 when the shift of the automatic transmission 10 ends. When the shift of the automatic transmission 10 ends at time t5, the deceleration 402 produced by the automatic transmission 10 reaches the maximum value 402max. At that time t5, the deceleration 402 alone produced by the automatic transmission 10 is sufficient to reach the maximum target deceleration Gt of the target deceleration 403 set (in step S4) to be substantially the same as the maximum value 402max of the deceleration 402 produced by the automatic transmission 10, so the brake control amount 406 can be zero. After step S9, step S10 is executed.

In step S10, the control circuit 130 outputs, and then gradually reduces, the brake torque (deceleration) for the amount of shift inertia to the brakes via the brake braking force signal SG1 that is output to the brake control circuit 230. The shift inertia is generated from between times t5 and t6 after the shift of the automatic transmission 10 has ended, through time t7 in FIG. 5. The shift inertia (i.e., inertia torque) is determined by a time differential value and an inertia value of a rotation speed of a rotating member of the automatic transmission 10 at time t5 when the shift of the automatic transmission 10 has ended.

In FIG. 5, step S10 is executed between time t5 and time t7. In order to keep shift shock to a minimum, the control circuit 130 sets the target deceleration 403 so its gradient is gradual after time t5. The gradient of the target deceleration 403 remains gradual until the target deceleration 403 reaches a final deceleration Ge obtained by a downshift of the automatic transmission 10. The setting of the target deceleration 403 ends when it reaches the final deceleration Ge. At that point, the final deceleration Ge, which is the engine brake desired by the downshift, acts on the vehicle as the actual deceleration of the vehicle, so from that point on, brake control according to the exemplary embodiment is no longer necessary.

In step S10, the brake control amount 406 for the shift inertia amount is supplied by the hydraulic pressure control circuit 220 in response to the brake control signal SG2 generated based on the brake braking force signal SG1 that was input to the brake control circuit 230. Then the brake control amount 406 is gradually reduced to correspond to the gradient of the target deceleration 403. After step S10, step S11 is executed.

In step S11, the control circuit 130 clears the flag F to 0 and resets the control flow.

According to this exemplary embodiment, the brakes are feedback controlled to compensate for the difference between the target deceleration 403 and the deceleration produced by the shift in response to the downshift command so that the sum of the deceleration produced by the shift in response to the downshift command and the deceleration produced by the brake control equals the target deceleration 403. In this case, feedback control is performed using the brakes which have better response than the automatic transmission, so the desired deceleration is able to be produced by the brakes. Accordingly, the target deceleration 403 can always be produced with good controllability as an overall result of the cooperative control of the automatic transmission and the brakes. As a result, the deceleration characteristics in response to the downshift command are able to be improved.

This exemplary embodiment enables ideal deceleration transitional characteristics to be obtained, as shown by the target deceleration 403 in FIG. 5. The deceleration smoothly shifts from the driven wheels to the non-driven wheels. Thereafter as well, the deceleration smoothly shifts to the final deceleration Ge obtained by the downshift of the automatic transmission 10. These ideal deceleration transitional characteristics are further described below.

That is, immediately after it is confirmed (i.e., immediately after there has been a determination) that there is a need for a downshift in step S3 (time t1), the brake control (step S7) that starts upon that confirmation (i.e., at time t1) causes the actual deceleration of the vehicle to gradually increase both at a gradient α that does not produce a large deceleration shock and within a range in which it is still possible to control a vehicle instability phenomenon should one occur. The actual deceleration of the vehicle increases until it reaches the maximum value 402max (≈maximum target deceleration Gt) of the deceleration 402 produced by the shift before time t3 when the shift starts. The actual deceleration of the vehicle then gradually falls, without producing a large shift shock at the end of the shift (after time t5), until it reaches the final deceleration Ge obtained by the shift.

As described above, according to this exemplary embodiment, the actual deceleration of the vehicle starts to increase quickly, i.e., immediately after time t1 when it has been confirmed that there is a need for a downshift. The actual deceleration of the vehicle then gradually increases until it reaches, at time t2 before time t3 when the shift starts, the maximum value 402max (≈maximum target deceleration Gt) of the deceleration 402 produced by the shift. The actual deceleration of the vehicle is then maintained at the maximum target deceleration Gt until time t5 when the shift ends.

If an instability phenomenon is going to occur in the vehicle from a temporal shift in the actual deceleration of the vehicle, as described above, it is highly likely that it will occur either while the actual deceleration of the vehicle is increasing to the maximum target deceleration Gt (between time t1 and time t2), or at the latest, by time t3 before the shift starts immediately after the actual deceleration of the vehicle has reached the maximum target deceleration Gt. During this period when it is highly likely that a vehicle instability phenomenon will occur, only the brakes are used to produce a deceleration (that is, the automatic transmission 10 which has not yet actually started to shift is not used to produce a deceleration). Because the brakes have better response than the automatic transmission, an instability phenomenon in the vehicle, should one occur, can be both quickly and easily controlled by controlling the brakes.

That is, the brakes can be quickly and easily controlled to reduce or cancel the brake braking force (i.e., the brake control amount 406) in response to an instability phenomenon of the vehicle. On the other hand, if an instability phenomenon occurs in the vehicle after the automatic transmission has started to shift, even if the shift is cancelled at that point, it takes time until the shift is actually cancelled.

Further, during the period mentioned above when the likelihood that an instability phenomenon will occur in the vehicle is high (i.e., from time t1 to time t2 or from time t1 to time t3), the automatic transmission 10 does not start to shift and the friction apply devices such as the clutches and brakes of the automatic transmission 10 are not applied, so no problem will result if the shift of the automatic transmission 10 is cancelled in response to the occurrence of an instability phenomenon in the vehicle.

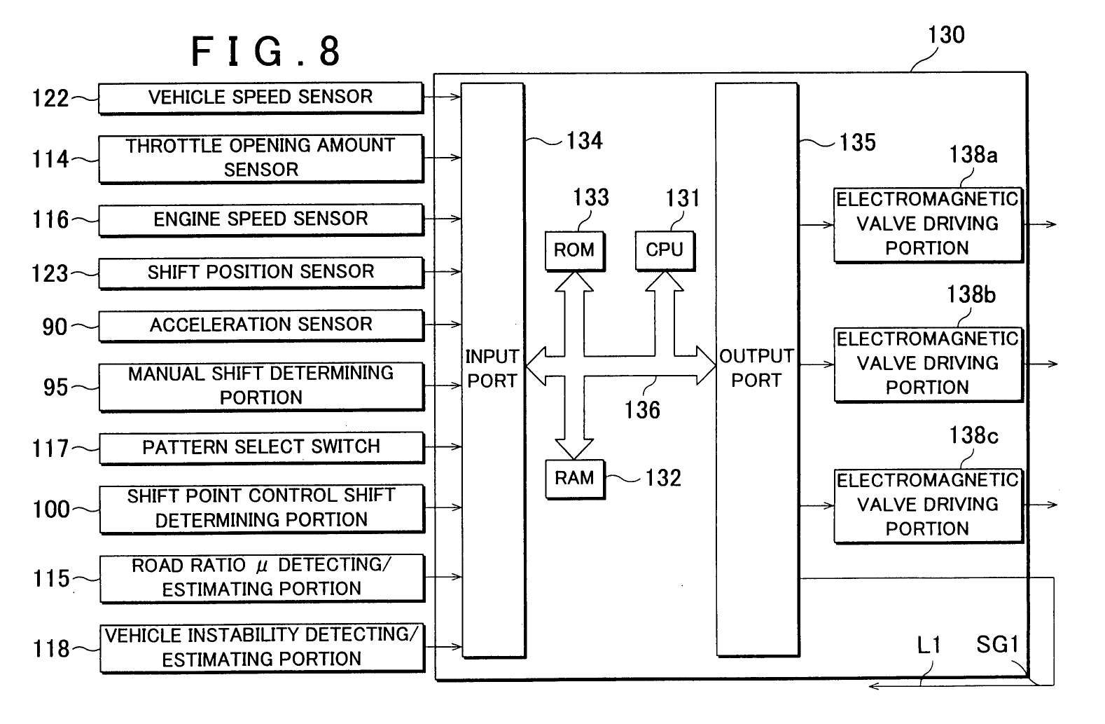

A second exemplary embodiment of the invention will now be described with reference to FIGS. 8 to 10. In the following description of the second exemplary embodiment, only those parts that differ from the first exemplary embodiment will be described; descriptions of parts that are the same as those in the first exemplary embodiment will be omitted.

The first exemplary embodiment as described above can be used for both a case of a manual shift and a case of a shift by shift point control. The second exemplary embodiment, however, assumes only a case in which the shift is performed by shift point control.

FIG. 8 is a block diagram schematically showing the peripheral devices of the control circuit 130 according to the second exemplary embodiment. In the second exemplary embodiment, a vehicle instability detecting/estimating portion road gradient measuring/estimating portion 118, which detects when the vehicle is unstable or estimates or anticipates that the vehicle will become unstable, is connected to the control circuit 130.

The vehicle instability detecting/estimating portion 118 detects, estimates, or anticipates an unstable state of the vehicle (a state in which the braking force/deceleration should be reduced), such as a decrease in the degree of grip of the tire, sliding, or unstable behavior, that has occurred or will occur for one reason or another (including a change in the road ratio μ and a steering operation). The following describes an example in which the vehicle instability detecting/estimating portion 118 detects or estimates a decrease in the degree of tire grip and control according to this exemplary embodiment is executed based on those detection or estimation results.

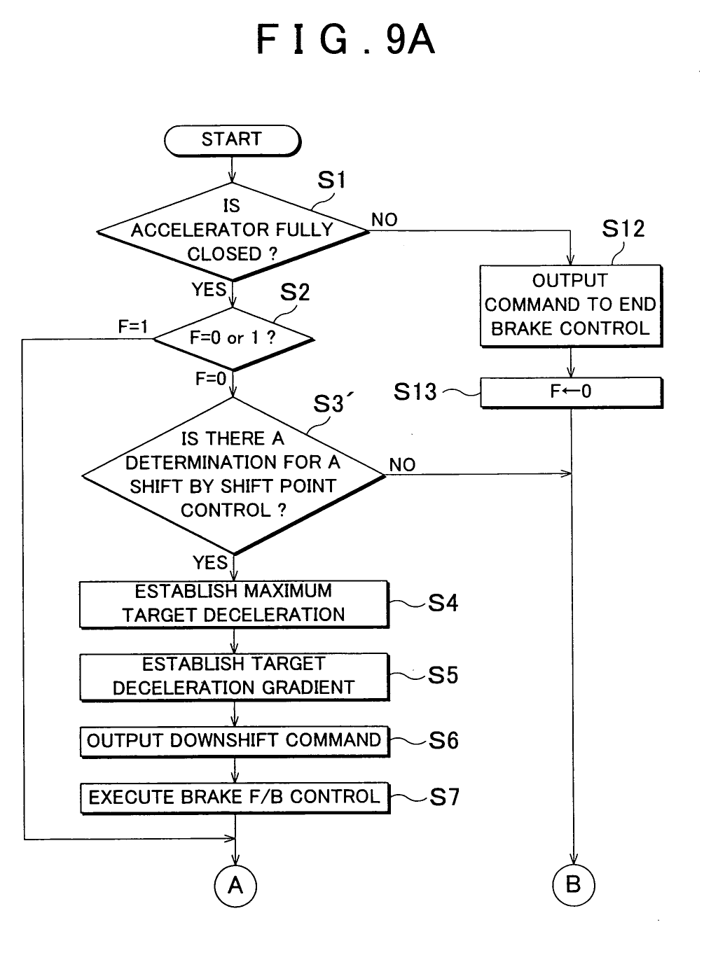

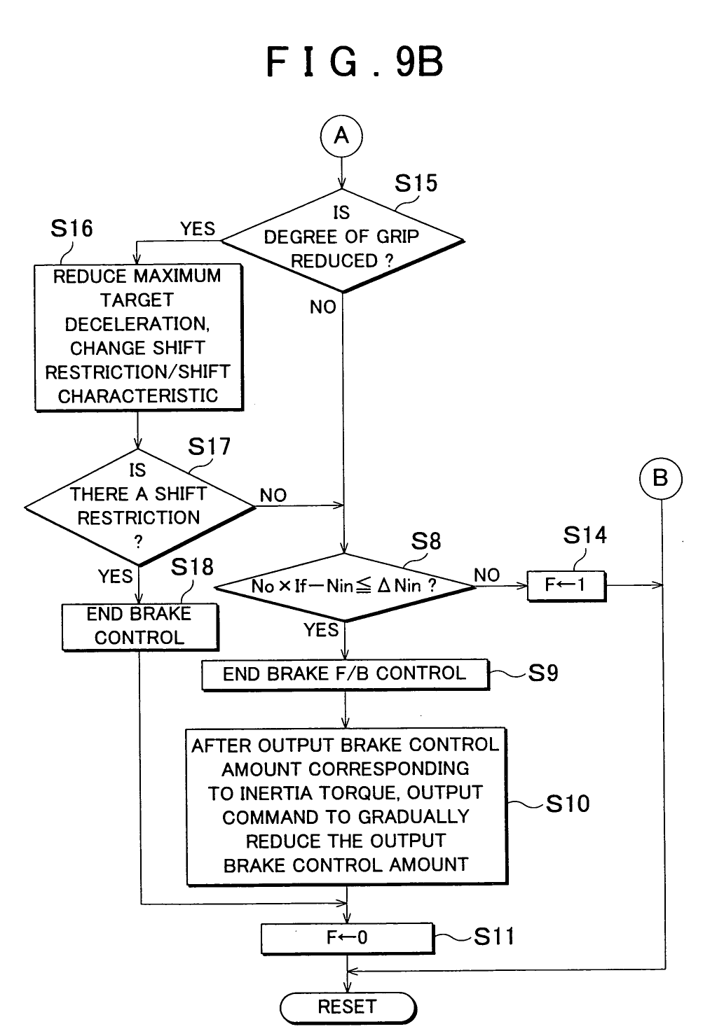

FIGS. 9A and 9B are flowcharts showing the control flow according to the second exemplary embodiment. This operation is stored in advance in the ROM 133. As shown in the drawing, the control flow of the second exemplary embodiment differs from the control flow (FIG. 1) of the first exemplary embodiment in that steps S15 to S17 have been added. Furthermore, step S3′ in FIG. 9A differs from step S3 in FIG. 1 in that in step S3′ in FIG. 9A, it is determined whether a command has been output for a downshift by shift point control.

A shift according to shift point control is not a downshift based on an intention originating in the driver, as is a manual shift. Therefore, even if a deceleration caused by the downshift (including both a deceleration caused by brake control and a deceleration caused by the shift (engine brake)) is corrected, that correction does not immediately contradict the intention of the driver.

Thus, according to this exemplary embodiment, when deceleration control (steps S3, S6, and S7) is executed in response to a downshift by shift point control, the deceleration is corrected (step S16) so that it is reduced when it is desirable to reduce the braking force/deceleration, such as when the degree of tire grip is low (i.e., YES in step S15).

In the case of shift point control, when a signal indicative of the need to downshift is output from the shift point control shift determining portion 100, it means that the shift point control shift determining portion 100 has set the deceleration to be achieved by the downshift into the target downshift speed specified by that signal as the aforementioned “target deceleration” to be set as the joint target of the brake system 200 and the automatic transmission 10, as described above. In this case it also means that the shift point control shift determining portion 100 has set the target downshift speed included in that signal as the “speed appropriate for achieving the target deceleration.”

However, according to this exemplary embodiment, when it is desirable that the braking force/deceleration be reduced, such as when the degree of tire grip is low, (i.e., YES in step S15), the aforementioned “target deceleration” that is set as the joint target of the brake system 200 and the automatic transmission 10 that was set based on the signal from the shift point control shift determining portion 100 is updated (step S16). The “speed appropriate for achieving the target deceleration” may also need to be reset (step S16) following an update of the “target deceleration” that is set as the joint target.

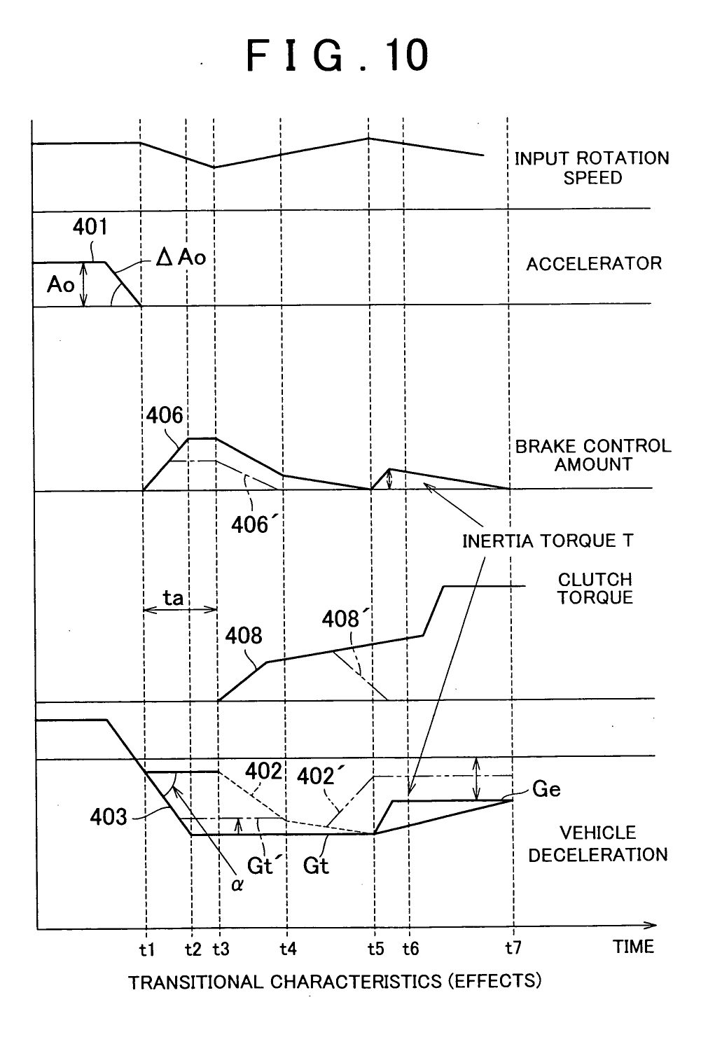

The control flow of the second exemplary embodiment will now be described with reference to FIGS. 9 and 10. Steps S1, S2, S4, S5, and S7 to S14 are the same as in the first exemplary embodiment so a description of these steps will be omitted.

In step S3′, the control circuit 130 determines whether a signal indicative of the need to downshift is being output from the shift point control shift determining portion 100. The FIG. 10 shows an example similar to that in FIG. 5, in which there has been a determination that there is a need to downshift by shift point control at time t1. When it has been determined in step S3′ that there is a need to downshift based on the signal from the shift point control shift determining portion 100 (i.e., YES in step S3′), the maximum target deceleration Gt is determined (step S14) and the gradient α of the target deceleration 403 is determined (step S5), after which step S6 is executed, just as in the first exemplary embodiment.

The target deceleration 403 (including the maximum target deceleration Gt and the gradient α) is included in the aforementioned “target deceleration” that is set as the joint target for the brake system 200 and the automatic transmission 10.

In step S6, a command for a downshift according to shift point control is output from the CPU 131 of the control circuit 130 to the electromagnetic valve driving portions 138a to 138c at time t1. Thereafter, brake feedback control is executed (step S7) at time t1, just as in the first exemplary embodiment. After step S7, step S15 is executed.

In step S7, the brake system 200 is feedback controlled to compensate for the difference between the target deceleration (403) and the deceleration produced by the shift into the speed appropriate for achieving the target deceleration (403) (i.e., into the target downshift speed corresponding to the downshift command), so that, as the overall result of the cooperative control of the brake system 200 and the automatic transmission 10, the target deceleration (403) acts on the vehicle, just as in the first exemplary embodiment. After step S7, step S15 is executed.

In step S15, the vehicle instability detecting/estimating portion 118 determines whether the degree of grip is less than a predetermined value. If it is determined that the degree of grip is less than the predetermined value (i.e., YES in step S15), the control circuit 130 reduces the maximum target deceleration Gt (step S16).

In FIG. 10, a maximum target deceleration Gt′, which is the maximum target deceleration Gt after being reduced in step S16, is shown by an alternate long and short dash line denoted by reference numeral 406′. As a result of reducing the maximum target deceleration Gt in step S16, the brake control amount 406 according to the brake feedback control that started in step S7 decreases, as shown by that alternate long and short dash line 406′.

In step S16, the control circuit 130 changes the shift restriction or shift transitional characteristics when necessary at the same time that the maximum target deceleration Gt is being reduced. A shift restriction refers to, for example, canceling the downshift in a case where the shift involves only one speed, and reducing the number of speeds to be shifted into by at least one in a case where a plurality of shifts are to be performed into two or more speeds. The decrease in the maximum target deceleration Gt indicates that the “target deceleration” described above, which is set as the overall target of the cooperative control, changes. As the “target deceleration” changes, it results in the resetting of the “speed that is appropriate for achieving the target deceleration” and the shift restriction mentioned above.

A shift can be canceled if necessary when the deceleration 402 caused by the shift of the automatic transmission 10 is larger than the maximum target deceleration Gt′ resulting from step S16, as shown in FIG. 10. In the case of a plurality of shifts of two or more speeds, only a shift, in which the deceleration is larger than the maximum target deceleration Gt′, can be canceled. Accordingly, the shift transitional characteristics can be changed.

In the example in FIG. 10, the deceleration 402 caused by the shift of the automatic transmission 10 is larger than the maximum target deceleration Gt′ so the shift of the automatic transmission 10 is cancelled. The deceleration caused by the automatic transmission 10 following that cancellation is shown by the chain double-dashed line denoted by reference numeral 402′. When the shift is cancelled, the deceleration 402′ caused by the shift of the automatic transmission 10 decreases, returning to the deceleration before the start of the shift. Also, when the shift of the automatic transmission 10 is cancelled, the clutch torque 408 of the automatic transmission 10 decreases, as shown by the chain double-dashed line denoted by reference numeral 408′.

In step S17, the control circuit 130 determines whether a shift restriction has been imposed in step S16. If a shift restriction has been imposed (i.e., YES in step S17), brake control following the shift is unnecessary so it ends (step S18) and the flag F is reset to 0 (step S11). If, on the other hand, it is determined in step S17 that a shift restriction has not been imposed (i.e., NO in step S17), step S8 is executed. Steps S8 onward are the same as in the first exemplary embodiment so descriptions thereof will be omitted here.

According to the second exemplary embodiment, when an instability phenomenon (such as a reduction in the degree of slip) has been detected, estimated, or anticipated in the vehicle (i.e., YES in step S15) when a downshift by shift point control is performed (step S6) and brake control corresponding to that downshift is performed (step S7), the maximum target deceleration Gt in FIG. 10 can be changed to a small value Gt′, as shown by the alternate long and short dashed line. As a result, the brake control amount 406 becomes a small value 406′, as shown by the alternate long and short dashed line. Also, when the deceleration 402 caused by the automatic transmission 10 exceeds the maximum target deceleration Gt′ following a downshift (step S6) of the automatic transmission 10 by shift point control, that shift can be cancelled if necessary (see the chain double-dashed line 402′ that branches off from the line denoted by the reference numeral 402 in FIG. 10).

From the description above, according to the second exemplary embodiment, when an instability phenomenon in the vehicle has occurred, or when it is anticipated that an instability phenomenon in the vehicle will occur, the actual deceleration of the vehicle decreases, making it easier to eliminate an instability phenomenon in the vehicle, prevent one from becoming worse, or prevent one from occurring in the first place. In the above description, when a shift restriction is imposed (i.e., YES in step S17), the brake control ends at that point (see brake control amount 406′ when the shift is cancelled).

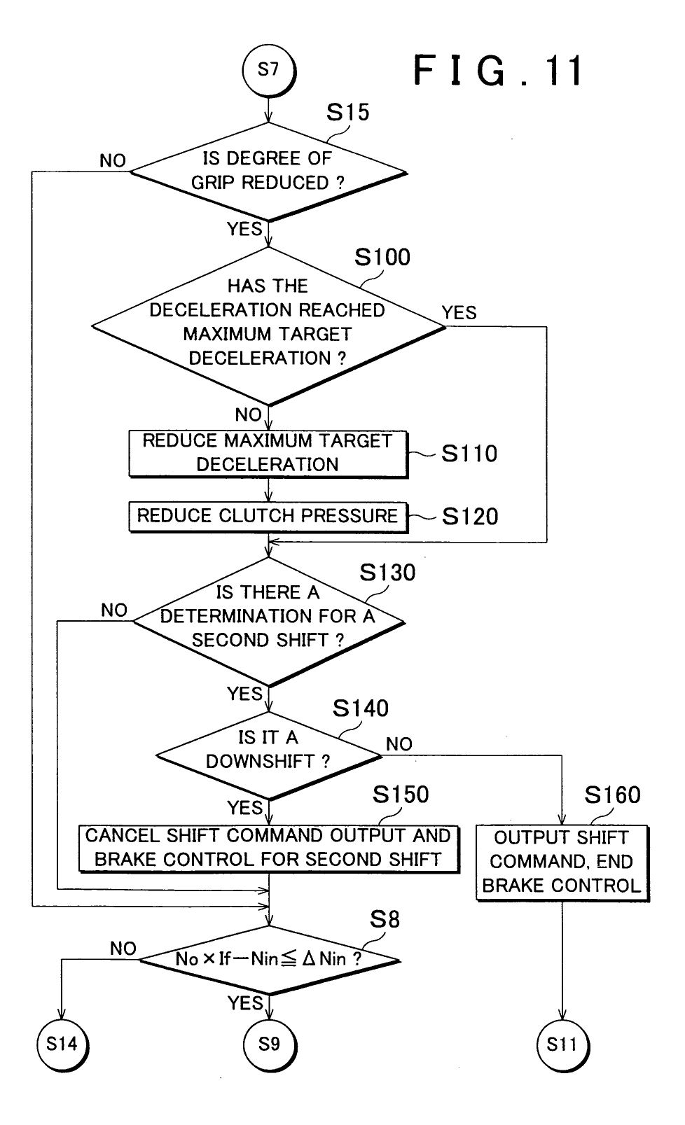

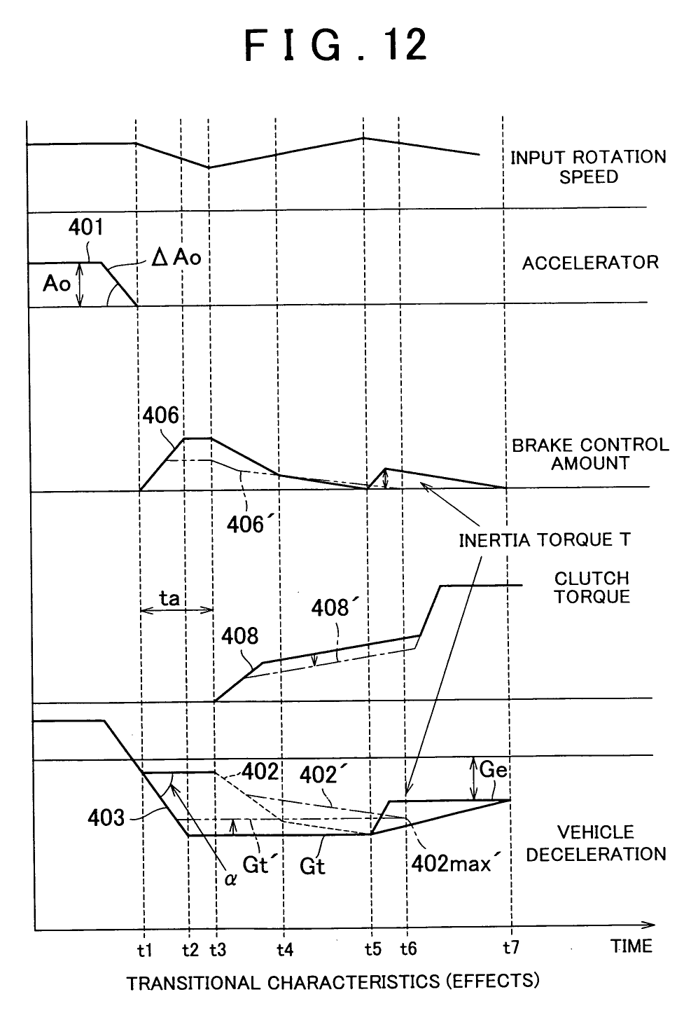

Next, a third exemplary embodiment of the invention will be described with reference to FIGS. 11 and 12. In the following description of the third exemplary embodiment, only those parts that differ from the foregoing exemplary embodiments will be described; descriptions of parts that are the same as those in the foregoing exemplary embodiments will be omitted.

The third exemplary embodiment assumes a downshift by shift point control, just like the second exemplary embodiment. The third exemplary embodiment, however, goes farther into the detail with step S16 of the second exemplary embodiment.

FIG. 11 is a flowchart showing the control flow of the third exemplary embodiment. The operation of the control flow is stored in advance in the ROM 133. FIG. 11 differs from FIGS. 9A and 9B showing the control flow of the second exemplary embodiment in two ways. First, steps S100 to S160 have been added between step S15 and step S8. Second, steps S17 and S18 in FIG. 9B have been omitted (as they correspond to steps S150 and S160) in FIG. 11. Steps S1 to S15 in FIG. 11 are the same as in the foregoing exemplary embodiment, so descriptions thereof will be omitted.

Step S100 is executed when the degree of grip becomes less than a predetermined value (i.e., YES in step S15) after a downshift by shift point control is performed at time t1 (step S6) and brake feedback control has started (step S7). In step S100, the control circuit 130 determines whether the target deceleration 403 or the actual deceleration of the vehicle has reached the maximum target deceleration Gt at the current point.

In the example in FIG. 12, before time t2, the target deceleration 403 or the actual deceleration of the vehicle is still sweeping down at the gradient α and has not yet reached the maximum target deceleration Gt, so the determination in step S100 is NO. In this case, step S110 is then executed. After time t2, on the other hand, the target deceleration 403 or the actual deceleration of the vehicle has reached the maximum target deceleration Gt, so the determination in step S100 is YES. In this case, step S130 is executed. That is, if the target deceleration 403 or the actual deceleration of the vehicle has reached the maximum target deceleration Gt (i.e., YES in step S100), the target deceleration 403 or the actual deceleration of the vehicle will not increase anymore so the routine proceeds directly on to step S130 without executing steps S110 and S120, which will be described next.

In step S110, the control circuit 130 reduces the maximum target deceleration Gt. More specifically, the value of the maximum target deceleration Gt reduced in step S110 (i.e., the value of the maximum target deceleration Gt′) is determined as follows. That is, because the degree of grip is reduced (step S15) while the target deceleration 403 or the actual deceleration of the vehicle is still increasing over time (i.e., NO in step S100) when step S110 is executed, the value of the target deceleration 403 or the actual deceleration of the vehicle at the point when step S110 is executed is made the new maximum target deceleration Gt′. The decrease in the maximum deceleration Gt indicates that the “target deceleration” set as the overall target of the cooperative control changes. After step S110, step S120 is executed.

In step S120, the control circuit 130 reduces the hydraulic pressure (clutch pressure) operating a clutch of the automatic transmission 10 by a predetermined value. More specifically, the control circuit 130 reduces the clutch pressure by controlling the operating states of the electromagnetic valves 121a to 121c using the electromagnetic valve driving portions 138a to 138c.

The deceleration caused by a shift of the automatic transmission 10 when the clutch pressure is reduced is denoted by reference numeral 402′. When the clutch pressure is reduced, the time required for the shift increases (to time t6) and the maximum value 402max′ of the deceleration 402′ caused by the shift decreases. In step S120, the decrease amount of the clutch pressure is a value corresponding to the decrease amount of the maximum target deceleration Gt′. As a result, the maximum target deceleration Gt′ and the deceleration of the maximum value 402max′ of the deceleration 402′ caused by the shift of the automatic transmission 10 are equal, as shown in FIG. 12.

Because step S120 is executed when the target deceleration 403 or the actual deceleration of the vehicle has not yet reached the maximum target deceleration Gt (i.e., before time t2) (i.e., NO in step S100), step S120 is executed before time t3 when the automatic transmission 10 actually starts to shift. As a result, the clutch pressure of the automatic transmission 10 can easily be reduced in step S120.

The brake control amount changes in response to a decrease in the maximum target deceleration Gt′ and a decrease in the clutch pressure (i.e., in response to a change in the deceleration 402′ caused by the shift of the automatic transmission 10), as shown by reference numeral 406′. In this exemplary embodiment, the brake control amount 406′ changes as a result of feedback control of the brake system 200 being performed in response to a change in the target deceleration 403 (the maximum target deceleration Gt′) and a change in the deceleration 402′ from a shift of the automatic transmission 10. Also, the clutch torque decreases in response to a decrease in clutch pressure, as shown by reference numeral 408′. After step S120, step S130 is executed.

In step S130, the control circuit 130 determines whether a determination has been made for a second shift while the current shift operation (hereinafter referred to as the “first shift”) is being performed. That is, the control circuit 130 determines whether a signal indicative of a need for a second shift, which is different from the first shift, is being output from either the manual shift determining portion 95 or the shift point control shift determining portion 100.

If it is determined that the signal indicative of a need for the second shift is being output (i.e., YES in step S130), step S140 is then executed. If, on the other hand, it is determined that the signal indicative of a need for the second shift is not being output (i.e., NO in step S130), step S8 is executed. Steps S8 onward are the same as those in the foregoing exemplary embodiment so descriptions thereof will be omitted here.

In step S140, the control circuit 130 determines whether the second shift is a downshift. If it is a downshift (i.e., YES in step S140), then step S150 is executed. If not (i.e., NO in step S140), i.e., if it is an upshift, then step S160 is executed.

In step S150, the control circuit 130 cancels both the downshift command corresponding to the signal indicating a need for the second shift that was output from either the manual shift determining portion 95 or the shift point control shift determining portion 100, and the brake control corresponding to the second shift.

When the second shift, which is a downshift, is to be performed, there is a possibility that the deceleration will increase as a result. If the degree of grip is low (i.e., YES in step S15) at this time, the vehicle may become even more unstable. In order to prevent this, the second shift command and the brake control corresponding to that second shift are cancelled in step S150. After step S150, step S8 is executed. The determination to end the shift in step S8 is directed towards the first shift.

In step S160, the control circuit 130 outputs the shift command corresponding to the signal indicating a need for the second shift that was output from either the manual shift determining portion 95 or the shift point control shift determining portion 100 and executes the second shift which is an upshift. At the same time, the control circuit 130 ends the brake control corresponding to the first shift. The fact that the command for the second shift, which is an upshift, was output (i.e., NO in step S140) indicates that the deceleration required by the first shift is no longer necessary. By performing the second shift which is an upshift, the deceleration 402 caused by the shift of the automatic transmission 10 also decreases. That is, when the command for the second shift, which is an upshift, is output (i.e., NO in step S140), there is no longer a need for the deceleration (the overall target deceleration of the cooperative control) required by the first shift, so it is cancelled. Therefore, when the command for the second shift, which is an upshift, has been output (i.e., NO in step S140), the brake control corresponding to the first shift is no longer necessary. The brake control ends when the overall target deceleration of the cooperative control is cancelled.

After the brake control has ended in step S160, the determination as to whether to end the shift for the first shift (i.e., step S8) is no longer necessary, so after step S160, step S11 is executed.

As described above, according to the third exemplary embodiment, when an instability phenomenon such as a decrease in the degree of grip has been detected or estimated in the vehicle (i.e., YES in step S15) when there is a downshift by shift point control, the maximum target deceleration Gt′ is reduced (step S110) which in turn results in the brake control amount 406′ being reduced. As a result, the actual deceleration of the vehicle decreases, making it easier to eliminate an instability phenomenon in the vehicle or prevent one from becoming worse.

Further, the clutch pressure of the automatic transmission 10 is simultaneously reduced (step S120) when an instability phenomenon such as a decrease in the degree of grip has been detected or estimated in the vehicle (i.e., YES in step S15) when there is a downshift by shift point control. Therefore, the maximum value 402max′ of the deceleration 402′ caused by the shift of the automatic transmission 10 can be reduced to near the maximum target deceleration Gt′ while the increase gradient of the deceleration 402′ caused by the shift can be made smooth (the shift transitional characteristics can be changed) without canceling the shift of the automatic transmission 10. As a result, it easier to eliminate an instability phenomenon in the vehicle or prevent one from becoming worse.

In this exemplary embodiment, the brakes, which have superior response, are feedback controlled in order to achieve the overall target deceleration of the cooperative control. As a result, even if the target deceleration 403 (i.e., the maximum target deceleration Gt′) and the deceleration 402′ of the automatic transmission 10 change, the brake control amount 406′ is changed in real time so it is able to accurately follow those changes.

If an instability phenomenon occurs in the vehicle, it is highly likely that it will occur during the period of increase in the target deceleration 403 or the actual deceleration of the vehicle (i.e., between times t1 and t2 in FIG. 12). During this period (i.e., from time t1 to time t2 in FIG. 12), only the brakes, which have good response, are used to produce a deceleration so any instability phenomenon in the vehicle can be easily controlled. That is, it is possible to quickly stop or reduce the braking force (brake control amount 406) by the brakes. Also during this period (i.e., from time t1 to time t2 in FIG. 12), the automatic transmission 10 has not yet started to shift so the clutch pressure can be reduced easily.

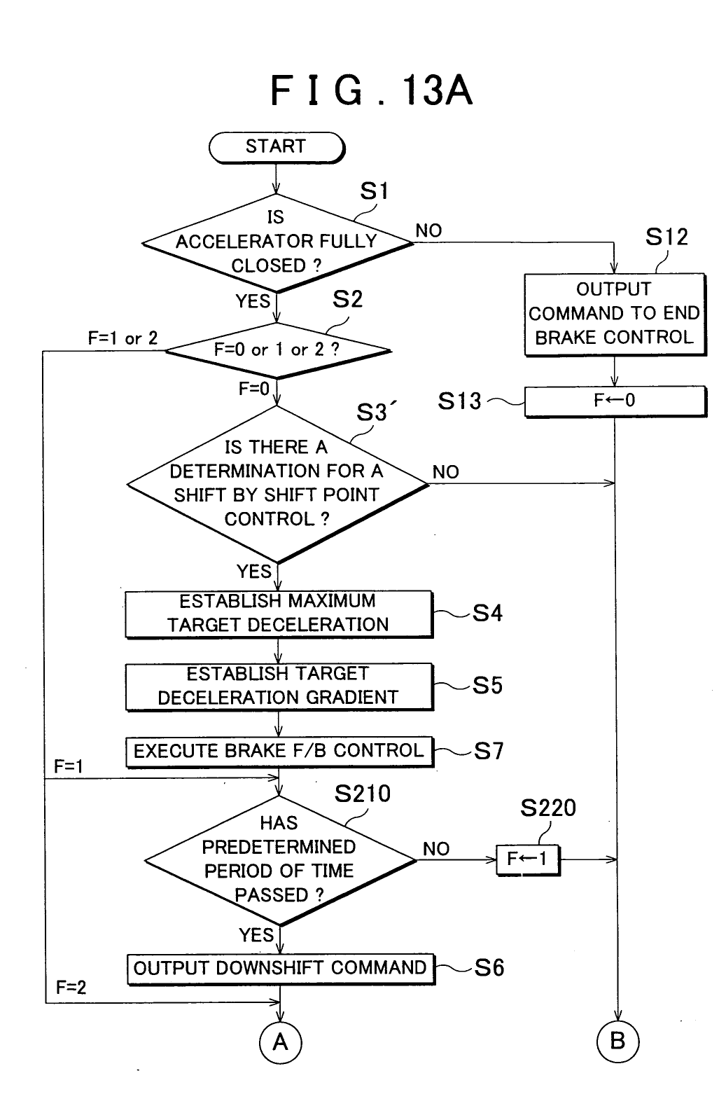

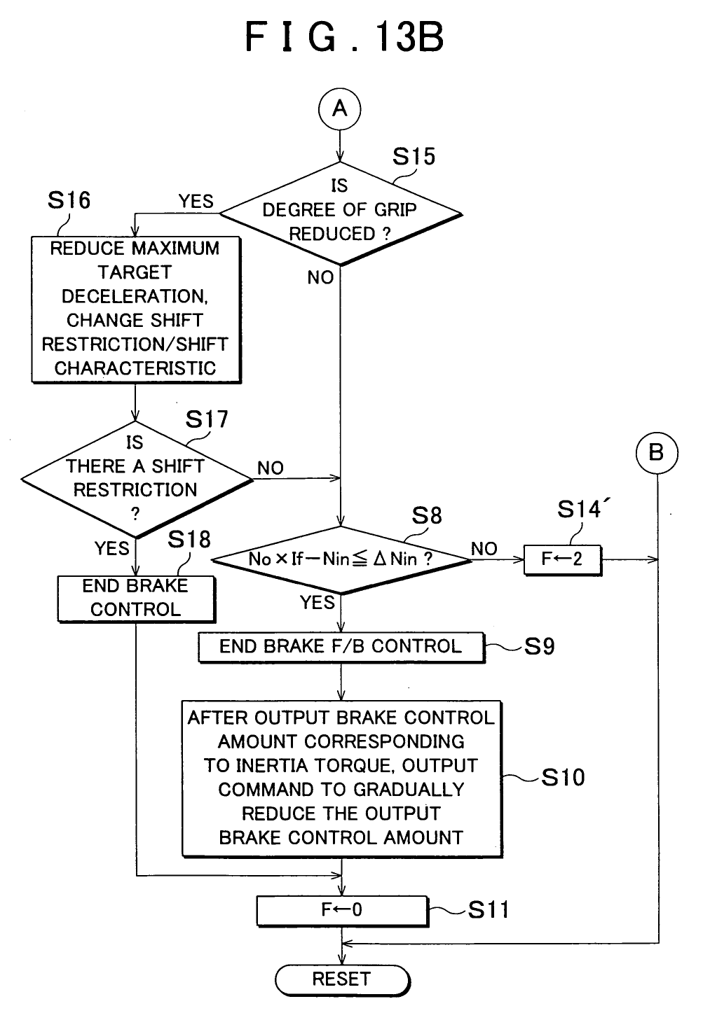

Next, a fourth exemplary embodiment of the invention will be described with reference to FIGS. 13A and 13B. In the following description of the fourth exemplary embodiment, only those parts that differ from the foregoing exemplary embodiments will be described; descriptions of parts that are the same as those in the foregoing exemplary embodiments will be omitted.

In the first through the third exemplary embodiments, the initial target deceleration 403 is set to increase to the maximum value 402max (≈maximum target deceleration Gt) of the deceleration 402 caused by the shift in the automatic transmission 10 at time t2 before time t3 when the automatic transmission 10 actually starts to shift (steps S4 and S5), which makes it easy to control an instability phenomenon in the vehicle should one occur.

In contrast, there may be cases where brake control alone is not sufficient to keep up with the target, or where the gradient α of the target deceleration 403 can not be set high due to the fact that it may result in deceleration shock. In such cases, it is thought that it may not be possible for the actual deceleration of the vehicle to reach the maximum value 402max (≈maximum target deceleration Gt) of the deceleration 402 caused by the shift of the automatic transmission 10 before time t3 when the shift starts. The fourth exemplary embodiment is particularly effective for dealing with this kind of situation.

FIGS. 13A and 13B are a flowchart showing the control flow of the fourth exemplary embodiment. The operation for this control flow is stored in advance in the ROM 133. As shown in FIGS. 13A and 13B, the control flow of the fourth exemplary embodiment differs from the control flow of the second exemplary embodiment shown in FIGS. 9A and 9B in that steps S210 and S220 have been added, and the order in which step S6 and step S7 are executed has been reversed. The steps in FIGS. 13A and 13B that are the same as those in the foregoing exemplary embodiments are denoted by the same reference numerals and descriptions thereof will be omitted.

Step S210 is executed after the brake feedback control has started in step S7. In step S210, the control circuit 130 determines whether a predetermined period of time has passed after the brake feedback control has started. If the predetermined period of time has passed (i.e., (YES in step S210), the routine proceeds on to step S6. If, on the other hand, the predetermined period of time has not passed (i.e., NO in step S210), the routine proceeds on to step S220.

At first, the predetermined period of time will not have passed (i.e., NO in step S210) so step S220 is executed. In step S220, the control circuit 130 sets the flag F to 1 and then resets the control flow. Then in step S2, the flag F is determined to be 1 so step S210 is then executed. The operation is repeated in this way until the predetermined time passes (i.e., YES in step S210), at which point step S6 is executed such that a downshift command is output.

As described above, in the second exemplary embodiment, both the brake control is started (step S7) and the downshift command is output (step S6) at time t1. In the fourth exemplary embodiment, however, the downshift command is output (step S6) a predetermined time after (step S210) the brake control is started (step S7; time t1). As a result, the time at which the shift is started can be delayed for a predetermined period of time. Therefore, the actual deceleration of the vehicle is able to reach the maximum value 402max (≈maximum target deceleration Gt) of the deceleration 402 caused by the shift of the automatic transmission 10 before the shift starts.

The predetermined time in step S210 is able to be changed by the control circuit 130 according to the type of shift. This is because the time from the time that the downshift command is output until the time that the shift starts changes depending on the type of shift.

In this exemplary embodiment, the time that the automatic transmission 10 starts to shift is delayed, but by performing cooperative control with the brakes (steps S4, S5, and S7), the vehicle actually starts to decelerate earlier than when it is decelerated by the shift of the automatic transmission 10 alone. Therefore, the driver is not aware that the starting time of the shift of the automatic transmission 10 is late, and any adverse effects from the delayed shift starting time are able to be kept to the minimum.

Step S14′ in FIG. 13B differs from step S14 in FIG. 9B in that, in step S14′ in FIG. 13B, the flag F is set to 2 instead of 1 because it is set to 1 in step S220.

In the fourth exemplary embodiment, the control flow differs from the control flow of the second exemplary embodiment shown in FIGS. 9A and 9B in that steps S210 and S220 have been added, and the order in which step S6 and step S7 are executed has been reversed. Alternatively, however, is also possible to add steps S210 and S220 and reverse the order in which step S6 and step S7 are executed in the control flow of the first exemplary embodiment (FIG. 1).

Moreover, in the above description, operation to avoid an instability phenomenon in the vehicle (such as a reduction in the degree of tire grip) is performed only in the case of a shift by shift point control. This kind of operation may also be performed in the case of a manual shift as well. In this case, the criteria (the degree of slip, in the above description) for performing the operation to avoid an instability phenomenon in the vehicle can be set differently for a manual shift than it is for a shift by shift point control. For example, in the case of a manual shift, the deceleration increases according to the intention of the driver, so it is possible to make the criteria stricter (i.e., make it more difficult for the avoidance operation to be performed) so that the result will not contradict the intention of the driver (i.e., the amount of increase in the deceleration will not be easily reduced).

Further, in the example described above, the degree of grip is used as an example of the criteria that is detected or estimated by the vehicle instability detecting/estimating portion 118 and used for performing the operation to avoid an instability phenomenon in the vehicle. Alternatively, however, other indicators, such as an actual occurrence of an instability phenomenon (such as slipping of the tires) (e.g., a detection made by a difference between the rotation speeds of the front and rear tires, etc.), vehicle yaw, or operating signals for VSC (vehicle stability control) may also be used. Furthermore, the criteria for the operation to avoid an instability phenomenon in the vehicle may also use different indicators depending on whether the shift is a shift by shift point control or a manual shift.

Next, a fifth exemplary embodiment will be described. Parts in the fifth exemplary embodiment that are the same as parts in the exemplary embodiments described above will be referred to by the same reference numerals, and detailed descriptions thereof will be omitted.

According to this exemplary embodiment, in an apparatus for cooperatively controlling a brake system and an automatic transmission when a manual downshift or a downshift by shift point control is performed, a common target deceleration to be achieved by a shift and the brakes is set and the brakes are at least feedback controlled. When commands for multiple shifts have been output and the new shift command is a downshift, control to achieve the target deceleration corresponding to the initial shift command smoothly shifts to control to achieve the new target deceleration corresponding to the new shift command.

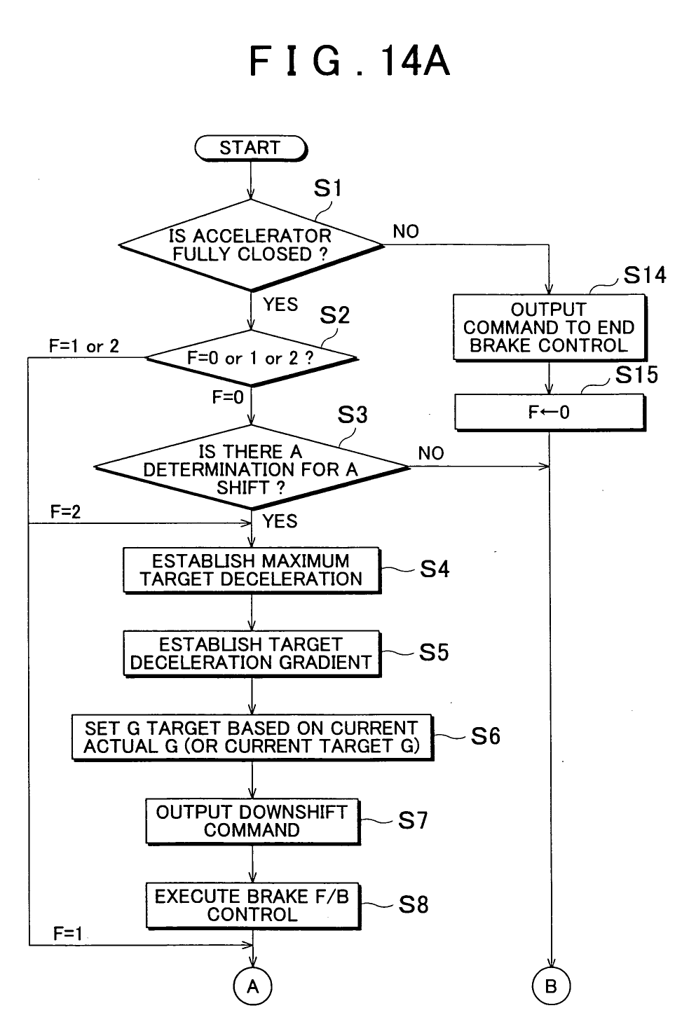

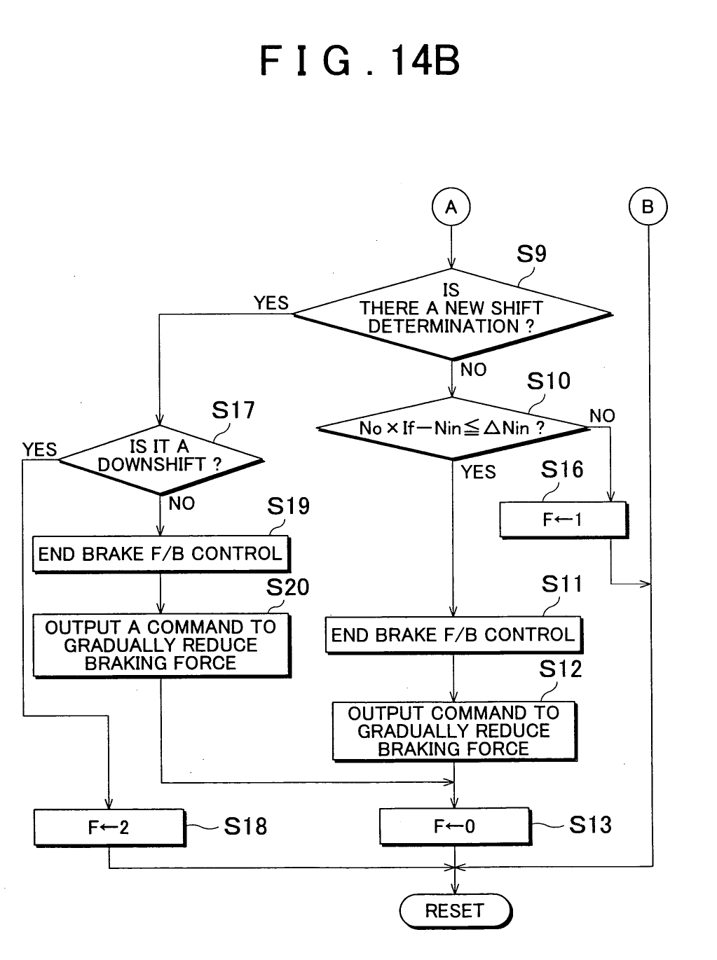

Next, operation of this exemplary embodiment will be described with reference to FIGS. 14, 15, and 16.

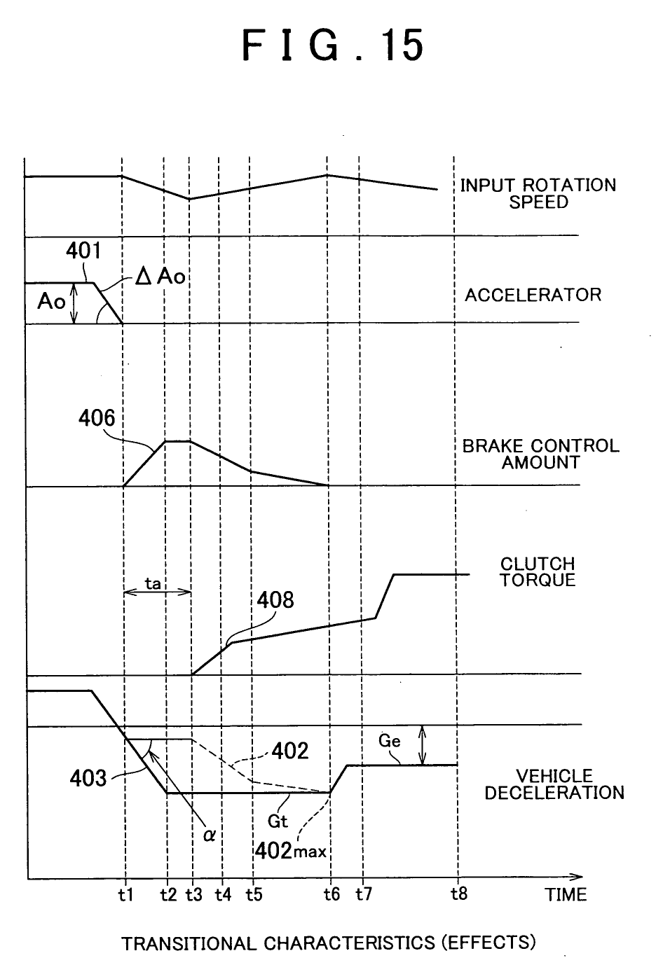

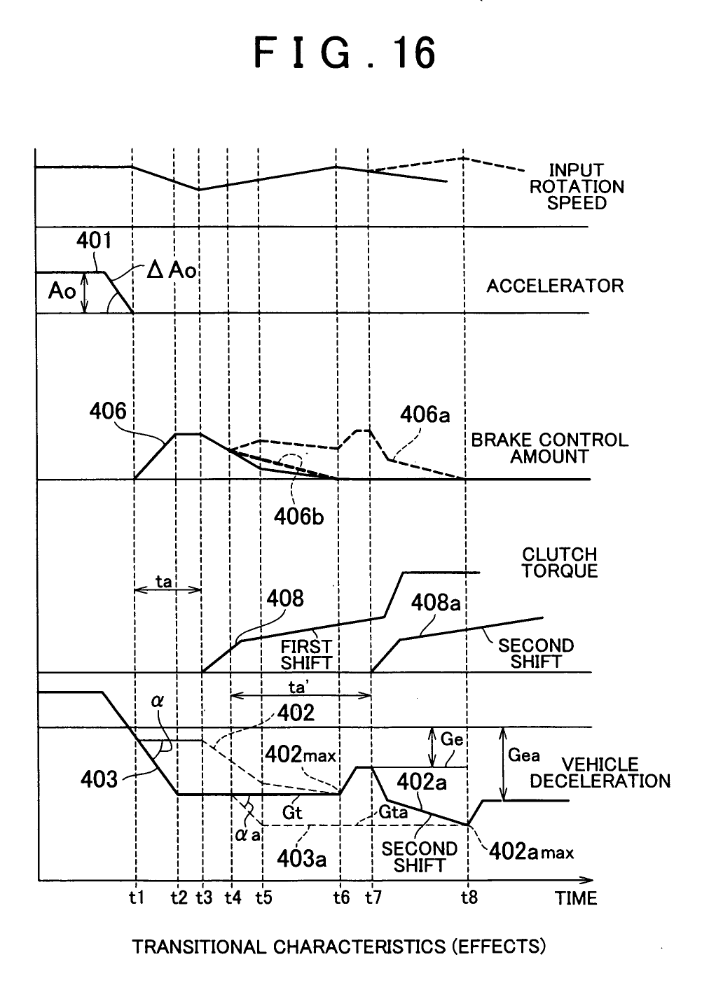

FIGS. 14A and 14B are flowchart illustrating the control flow of this exemplary embodiment. FIG. 15 is a time chart showing a first case in the exemplary embodiment, while FIG. 16 is a time chart showing a second case in the exemplary embodiment. FIGS. 15 and 16 both show the input rotation speed of the automatic transmission 10, the accelerator opening amount, the brake control amount, the clutch torque, and the deceleration (G) acting on the vehicle.

The first case will now be described with reference to FIGS. 14 and 15. Steps S1 to S5 are basically the same as steps S1 to S5 in FIG. 1 described above so a description thereof will be omitted here. However, time t4 in FIG. 15 is earlier than it is (i.e., between time t3 and time t4) in FIG. 5. As a result, time t5 in FIG. 15 corresponds to time t4 in FIG. 5, time t6 in FIG. 15 corresponds to time t5 in FIG. 5, and so on.

In step S6, the control circuit 130 sets the target deceleration 403 based on the current actual deceleration of the vehicle or the current target deceleration 403. In the example in FIG. 15, the target deceleration 403 is initially set based on the actual deceleration of the vehicle at time t1. The actual deceleration of the vehicle at time t1 corresponds to the starting point of the target deceleration 403 in FIG. 15. After the start (i.e., after the brake control in step S8 starts) the target deceleration 403 is set based on the either the current actual deceleration of the vehicle or the current target deceleration 403.

If the target following performance (following ability) of the brake feedback control in step S8, which will be described later, is good, then either the current actual deceleration of the vehicle or the current target deceleration 403 may be used in step S6. After step S6, step S7 is executed.

Steps S7 and S8 are basically the same as steps S6 and S7 in FIG. 1.

That is, in the brake system 200, the brake braking force (i.e., brake control amount 406) is controlled in step S8 so that the actual deceleration of the vehicle comes to match the target deceleration 403. That is, the brake control amount 406 is set so that, when producing the target deceleration 403 in the vehicle, it produces a deceleration that makes up for the difference between the deceleration 402 caused by the shift of the automatic transmission 10 and the target deceleration 403 in the vehicle, so that the target deceleration 403 can be achieved by the vehicle.

In step S9, it is determined by the control circuit 130 whether there is a determination to shift again (i.e., a new shift) (that is, whether there is new shift command) before the shift corresponding to the downshift command output in step S7 has ended. More specifically, it is determined whether a signal indicative of a need to shift again has been output from either the manual shift determining portion 95 or the shift point control shift determining portion 100.

If it is determined in step S9 that a signal indicative of the need to shift again has been output from either the manual shift determining portion 95 or the shift point control shift determining portion 100 (i.e., YES in step S9), then step S17 is executed. If not (i.e., NO in step S9), then step S10 is executed.

In the first case, step S9 in FIG. 15 is executed at time t4 and it is determined that a signal indicative of the need to shift again has not been output from either the manual shift determining portion 95 or the shift point control shift determining portion 100 (i.e., NO in step S9). Therefore, in the first case, after step S9 is executed, the process proceeds on to step S10.

Steps S10 and S11 are the same as steps S8 and S9 in the FIG. 1 so a description of these steps will be omitted.

In step S12, the control circuit 130 and the brake control circuit 230 gradually reduce the brake control amount 406. A signal indicative of the gradual reduction of the brake amount is output as the brake braking force signal SG1 from the control circuit 130 to the brake control circuit 230 via the brake braking force signal line L1. The brake control circuit 230 then generates the brake control signal SG2 corresponding to that gradual reduction of the brake amount based on the brake braking force signal SG1, and outputs it to the hydraulic pressure control circuit 220.

Step S12 is executed when it has been determined that the shift of the automatic transmission 10 is ending (or close thereto) (i:e., YES in step S10), after the feedback control of the brake has ended (step S11). Step S12 ends when the brake control amount 406 becomes zero. After the brake control amount 406 becomes zero, the actual deceleration of the vehicle is maintained at the final deceleration Ge obtained by the downshift of the automatic transmission 10. After step S12, step S13 is executed. Step S13 is the same as step S11 in FIG. 1.

Operation in the first case described above enables the deceleration transitional characteristics shown in FIG. 15 to be achieved. Next, a second case will be described with reference to FIGS. 14 and 16. A description of the details that are the same as those in the first case will be omitted.

The second case is identical to the first case up until right before time t4, as shown in FIGS. 15 and 16. In the second case, the determination in step S9 is made at time t4, just as in the first case, but the result of that determination is different. That is, in the second case, it is determined that a signal indicative of a need to shift again has been output from the manual shift determining portion 95 or the shift point control shift determining portion 100 (i.e., YES in step S9). As a result, the process proceeds on to a different step in the second case than it does in the first case (i.e., after step S9, the process proceeds on to step S17 instead of step S10). Thus, the following description will start with the determination in step S9 at time t4.

In step S9, the control circuit 130 determines whether there is a determination (i.e., a command) for new shift before the shift corresponding to the downshift command output in step S7 has ended, just as described above.

In the second case, in regard to the signal indicating a need for a new shift output from the manual shift determining portion 95 or the shift point control shift determining portion 100, the control circuit 130 determines at time t4 that there is a need for a new shift (i.e., YES in step S9). In this case, step S17 is then executed.

In step S17, it is determined whether the need for the new shift from the manual shift determining portion 95 or the shift point control shift determining portion 100 determined in step S9 relates to a downshift. If so, i.e., if it does relate to a downshift, then step S18 is executed. If, on the other hand, it is determined that it does not relate to a downshift but rather an upshift, step S19 is executed. In the following description, it is assumed that the new shift is a downshift.

In step S18, the control circuit 130 sets the flag F to 2 and then resets the control flow.

When the control flow is reset via step S18, the process returns to step S1. In the second case, because the accelerator is fully closed at time t4 (i.e., YES in step S1), the process proceeds on to step S2. In step S2 it is determined that the flag F is 2 so step S4 is executed.

In step S4, a maximum target deceleration Gta corresponding to the new shift is determined, just like in step S4 the first time. The maximum target deceleration Gta is determined so as to be the same (or close) to the maximum deceleration determined from the vehicle speed and the type of new shift that was determined necessary in step S9. In FIG. 16, the solid line denoted by reference numeral 402a indicates the deceleration that corresponds to the negative torque of the output shaft 120c of the automatic transmission 10 determined from the type of shift and the vehicle speed. The maximum target deceleration Gta is determined so as to be substantially the same as a maximum value 402amax of the deceleration 402a that acts on the vehicle from the shift of the automatic transmission 10. The maximum value 402amax of the deceleration 402a produced from the shift of the automatic transmission 10 is determined referencing the maximum deceleration map described above. After step S4, step S5 is executed.

In step S5, a gradient αa of a target deceleration 403a is determined just like in step S5 the first time. That is, when determining this gradient αa, an initial gradient minimum value of the target deceleration 403a is first determined based on a time ta′ from after the downshift command is output (at time t4 in step S7) until the shift actually starts (time t7), such that the actual deceleration of the vehicle reaches the maximum target deceleration Gta by time t6 when the shift starts. The time ta′ from time t4 when the downshift command is output until time t7 when the shift actually starts is determined based on the type of shift, just as described above.

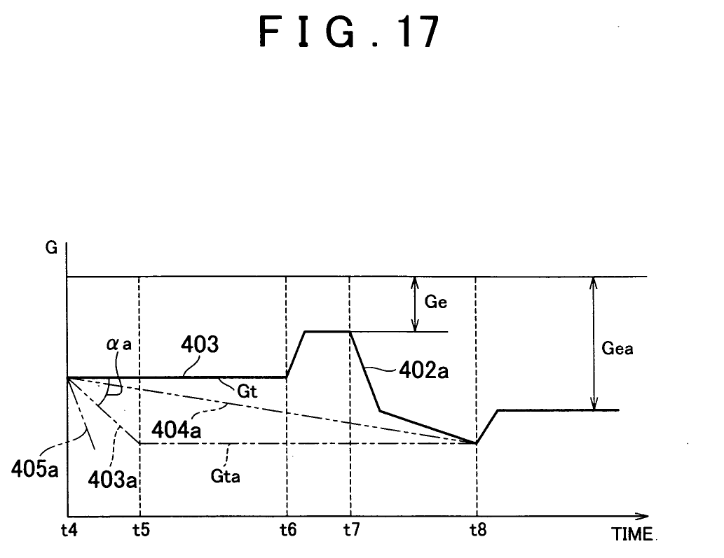

In FIG. 17, the chain double-dashed line denoted by reference numeral 404a corresponds to the initial gradient minimum value of the target deceleration. Also, the chain double-dashed line denoted by reference numeral 405a in FIG. 17 corresponds to the gradient upper limit value. In step S5, the gradient αa of the target deceleration 403a is set larger than the gradient minimum value 404a but smaller than the gradient upper limit value 405a, as shown in FIG. 17. The gradient αa of the target deceleration 403a determines the braking shock that acts on the vehicle at time t4 when the new downshift command is output, so the gradient upper limit value 405a is set so as to suppress that braking shock.

In steps S4 and S5, the target deceleration 403a is determined as indicated by the broken bold line in FIG. 16. That is, as shown in FIG. 16, the target deceleration 403a is set to reach the maximum target deceleration Gta at the gradient αa. Thereafter, the target deceleration 403a is maintained at the maximum target deceleration Gta until time t8 when the shift of the automatic transmission 10 ends. This is done in order to achieve a deceleration until the maximum deceleration 402amax (≈maximum target deceleration Gta) produced by the shift of the automatic transmission 10 is reached, using the brakes, which have good response, while quickly suppressing deceleration shock. After step S5, step S6 is executed.

In step S6, the control circuit 130 sets the target deceleration 403a corresponding to the new downshift based on the current actual deceleration of the vehicle or the current target deceleration 403. In this case, the current actual deceleration of the vehicle or the current target deceleration 403 at time t4 corresponds to the target deceleration 403 at time t4. In step S6, the target deceleration 403a is set based on this. After step S6, step S7 is executed.

In step S7, the new downshift command is output from the CPU 131 of the control circuit 130 to the electromagnetic valve driving portions 138a to 138c, as described above. When it is determined by the control circuit 130 at time t4 that there is a need to downshift (i.e., YES in step S9), the new downshift command is output simultaneously with that determination (i.e., at time t4).

As shown in FIG. 16, when the new downshift command is output at time t4 (i.e., step S7), the automatic transmission 10 actually starts to shift at time t7, which is after the period of time ta′ determined based on the type of shift has passed from that time (i.e., from when the command was output at time t4). When the automatic transmission 10 actually starts to shift, the clutch torque 408a starts to increase, as does the deceleration 402a produced by the shift of the automatic transmission 10.

The downshift corresponding to the initial downshift command continues to be executed (as in the first case described above) even after time t4 when the new downshift command is output, as indicated by the deceleration 402 produced by the shift of the automatic transmission 10. The shift then ends at time t6, after which the deceleration is maintained at the final deceleration Ge produced by the initial downshift. The new downshift then starts at time t7 and ends at time t8, as shown by reference numeral 402a, after which the deceleration is maintained at the final deceleration Gea produced by the new downshift. After step S7, step S8 is executed.

In step S8, the brake feedback control which started in response to the initial downshift command continues to be executed. The brake feedback control is performed, as shown by the brake control amount 406a in response to the new downshift, so that the deceleration of the vehicle corresponds to the target deceleration 403a.

In the example in FIG. 16, the deceleration 402 produced by the automatic transmission 10 according to the initial downshift is generated from time t4 when the new downshift command is output until time t6 when the new downshift ends. Therefore, in order to reach the target deceleration 403a, the brake control amount 406a is generated to produce a deceleration that makes up for the difference between the deceleration 402 produced by the automatic transmission 10 and the target deceleration 403a.

In the same way, the final deceleration Ge is produced by the automatic transmission 10 according to the initial downshift from time t6 to time t7. Therefore, in order to reach the target deceleration 403a, the brake control amount 406a is generated to produce a deceleration that makes up for the difference between the final deceleration Ge and the target deceleration 403a. Similarly, the deceleration 402a produced by the automatic transmission 10 according to the new downshift is generated from time t7 to time t8, so in order to reach the target deceleration 403a, the brake control amount 406a is generated to produce a deceleration that makes up for the difference between the deceleration 402a and the target deceleration 403a.

In step S9, it is determined whether there is a determination to shift again (i.e., a new shift) (that is, whether there is new shift command) before the shift corresponding to the downshift command output in step S7 has ended, as described above. In regard to the signal indicating a need for a new shift output from the manual shift determining portion 95 or the shift point control shift determining portion 100, the control circuit 130 determines that there is no need for a new shift (i.e., NO in step S9) between time t4 and time t8 in FIG. 16. In this case, step S10 is then executed.

In step S10, it is determined whether the aforementioned relational expression is satisfied. If the relational expression is not satisfied, the routine is repeated until it is. When the relational expression in step S10 has been satisfied, step S11 is then executed. In FIG. 16, the shift in response to the new downshift command ends at time t8, such that the relational expression is satisfied. As can be seen in FIG. 16, the deceleration 402a that acts on the vehicle from the new downshift reaches the maximum value 402amax (≈maximum target deceleration Gta) at time t8, indicating that the shift of the automatic transmission 10 has ended.

In step S11, the brake feedback control, which started at time 1 in step S8 the first time in response to the initial downshift command and was then continued by the new downshift command, ends. After step S11, the control circuit 130 no longer includes the signal corresponding to the brake feedback control in the brake braking force signal SG1 that is output to the brake control circuit 230.

That is, the brake feedback control is performed until the shift (i.e., the new downshift) of the automatic transmission 10 ends. As shown in FIG. 16, the brake control amount 406a is zero at time t8 when the shift of the automatic transmission 10 ends. When the shift of the automatic transmission 10 ends at time t8, the deceleration 402a produced by the automatic transmission 10 reaches the maximum value 402amax. At that time t8, the deceleration 402a alone produced by the automatic transmission 10 is sufficient to reach the maximum target deceleration Gta of the target deceleration 403a set (in step S4) to be substantially the same as the maximum value 402amax of the deceleration 402a produced by the automatic transmission 10, so the brake control amount 406a can be zero. After step S11, step S12 is executed.

In step S12, the brake control amount 406a is gradually reduced. If, however, the brake control amount 406a is already zero at the time step S12 is executed, as shown in FIG. 16, then this step is essentially not executed. After the brake control amount 406a reaches zero, the actual deceleration of the vehicle becomes equivalent to the deceleration produced by the new downshift of the automatic transmission 10, and is thereafter maintained at the final deceleration Gea produced by the new downshift. After step S12, step S13 is executed as described above.

Next, the second case, in which the new shift is an upshift (i.e., NO in step S17), will be described.

In step S19, the brake feedback control that started in step S8 in response to the initial downshift command ends, just as in step S11. After step S19, the control circuit 130 no longer includes the signal corresponding to the brake feedback control in the brake braking force signal SG1 that is output to the brake control circuit 230.

In the example shown in FIG. 16, the brake control amount when the new shift that was determined necessary at time t4 (i.e., YES in step S9) is an upshift (i.e., NO in step S17) is indicated by reference numeral 406b, shown by the alternate long and short dash line from time t4. The brake control amount 406b is not generated by feedback control (step S19), but is rather controlled to decrease gradually in step S20, as described below.

When the new shift is an upshift (i.e., NO in step S17), it means that the deceleration from the initial downshift that was determined necessary in step S3 the first time (i.e., at time t1) is no longer necessary. Further, by performing the upshift as the new shift, the deceleration from the shift of the automatic transmission 10 would decrease (not shown). Therefore, when the new shift is an upshift (i.e., NO in step S17), the brake feedback control that started in step S8 at time t1 ends (i.e., step S19). After step S19, step S20 is executed.

In step S20, the control circuit 130 and the brake control circuit 230 gradually reduce the brake control amount 406b, just as in step S12. Step S20 ends when the brake control amount 406b becomes zero (at time t6). After the brake control amount 406b becomes zero, the actual deceleration of the vehicle becomes a value that corresponds to the engine braking force by the automatic transmission 10. After step S20, step S13 is executed as described above.

In the second case, in regard to the signal indicating a need for a new shift output from the manual shift determining portion 95 or the shift point control shift determining portion 100, an example is given in which it has been determined by the control circuit 130 that there is a need for a new shift (i.e., YES in step S9) at time t4 after time t3 when the initial downshift started. In this exemplary embodiment, however, the timing at which it is determined that there is a need for a new shift (i.e., YES in step S9) may also be before time t3 when the initial downshift starts, as long as it is after time t1 when the initial downshift command is output. As long as that timing is after time t1 when the initial downshift command is output, the target deceleration 403a corresponding to the new downshift command is set and deceleration control corresponding to that target deceleration 403a takes over from the deceleration control corresponding to the initial downshift command.

Similarly, in this exemplary embodiment, the timing at which it is determined that there is a need for a new shift (i.e., YES in step S9) need only be before time t6 when the initial downshift ends (i.e., YES in step S10). In this case, the target deceleration 403a corresponding to the new downshift command is set and deceleration control corresponding to that target deceleration 403a takes over from the deceleration control corresponding to the initial downshift command.

Next, the effects of this exemplary embodiment will be described. In the second case in this exemplary embodiment, before it has been determined that the initial (nth) downshift has ended (step S10), a new (nth+1) shift determination is made (step S9). A new target deceleration is set (i.e., the target deceleration is updated) every time a new shift is performed.

Here, the brakes, which have good response, are feedback controlled in order to achieve the overall target deceleration of the cooperative control. Therefore, even if the target deceleration 403a corresponding to the new shift determination changes or the deceleration 402a from a new shift of the automatic transmission 10 is produced, the brake control amount 406a is changed in real time so it is able to accurately follow those changes.

As shown in the second case, it is also possible to handle a shift command for either a downshift or an upshift that is generated before the initial downshift ends. In this exemplary embodiment, the period until the shift ends (step S10) is regarded as one control unit. Alternatively, however, the period up until the braking force becomes zero may be regarded as one control unit.

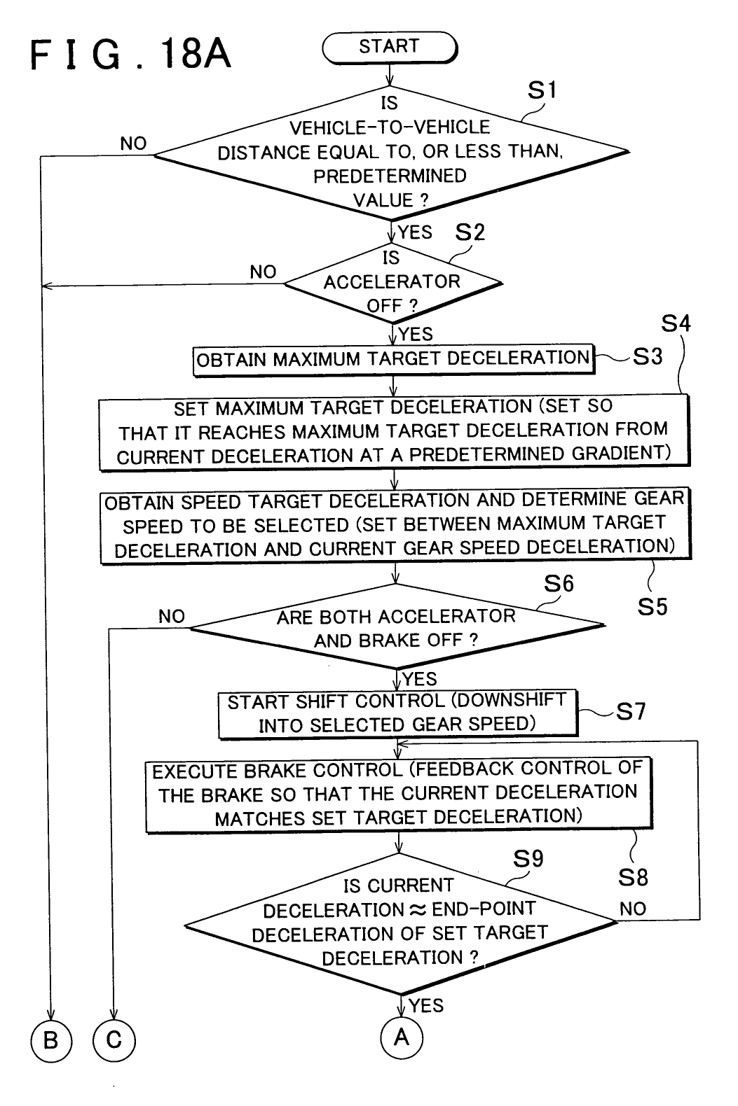

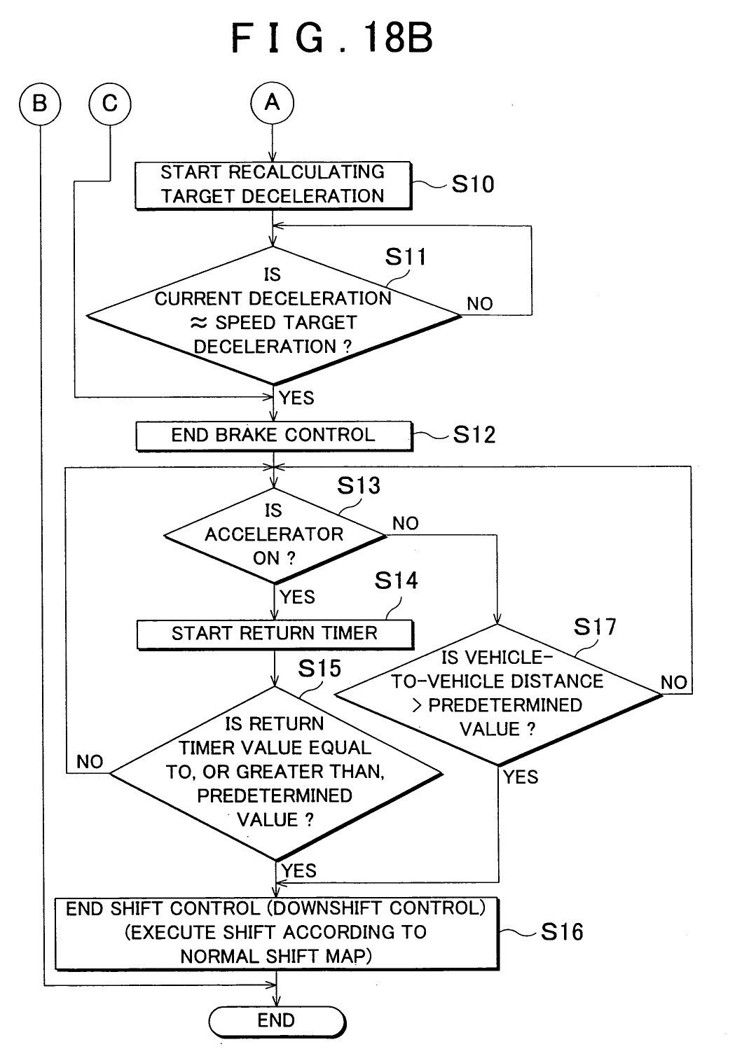

Next, a sixth exemplary embodiment of the invention will be described with reference to FIGS. 18A to 29. Parts in the sixth exemplary embodiment that are the same as parts in the foregoing exemplary embodiments are denoted by the same reference numerals, and detailed descriptions thereof will be omitted.

This exemplary embodiment provides a deceleration control that incorporates the advantages of good response and controllability offered by the brakes by performing brake control (automatic brake control), as well as the advantage of increased engine braking offered by a downshift by performing shift control (downshift control by an automatic transmission), in cooperation with one another when it is detected, based on vehicle-to-vehicle distance information, that the distance between vehicles is equal to, or less than, a predetermined value.

In terms of the structure of this exemplary embodiment, it is assumed that means capable of measuring the distance between a host vehicle and a preceding vehicle, and a deceleration control apparatus that operates a brake and a shift control of an automatic transmission in cooperation with one another based on that distance information, are provided. These will be described in detail below.

As shown in FIG. 19, this exemplary embodiment is provided with a relative vehicle speed detecting/estimating portion 95a and a vehicle-to-vehicle distance measuring portion 100a instead of the manual shift determining portion 95 and the shift point control shift determining portion 100 in FIG. 2. The relative vehicle speed detecting/estimating portion 95a detects or estimates the relative speed between a host vehicle and a preceding vehicle. The vehicle-to-vehicle distance measuring portion 100a has a sensor such as a laser radar sensor or a millimeter wave radar sensor mounted on the front of the vehicle, which is used to measure the distance to the preceding vehicle.

The control circuit 130 inputs both a signal indicative of the detection or estimation results from the relative vehicle speed detecting/estimating portion 95a and a signal indicative of the measurement results from the vehicle-to-vehicle distance measuring portion 100a. The operation (control steps) indicated in the flowchart in FIGS. 18A and 18B is stored in the ROM 133 beforehand.

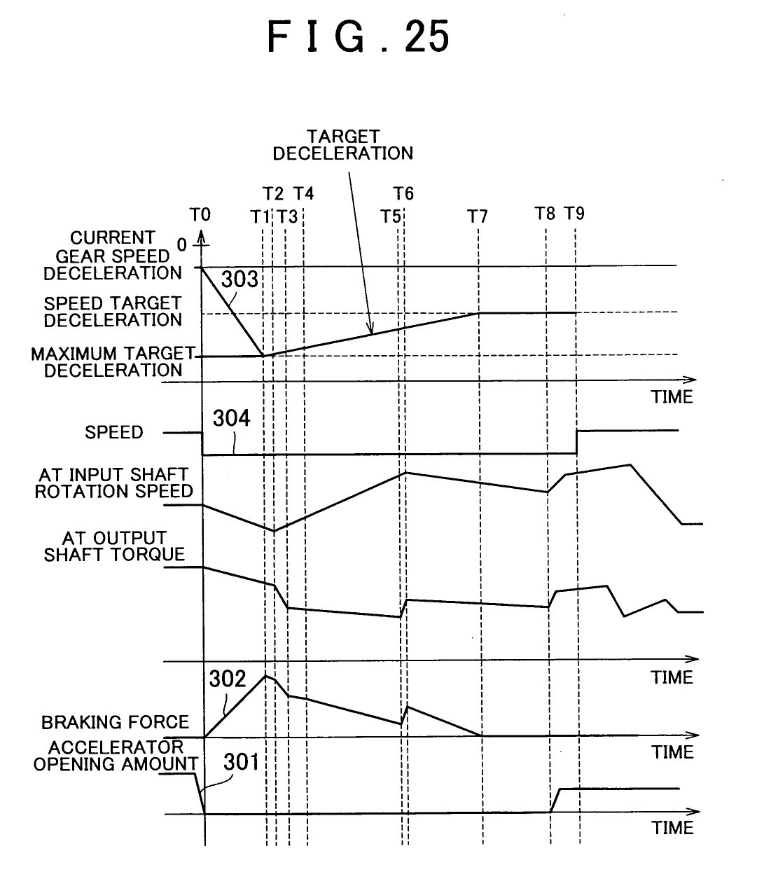

The operation of this exemplary embodiment will now be described with reference to FIGS. 18A, 18B, 19, and 25. FIG. 25 is a time chart illustrating the deceleration control of this exemplary embodiment. FIG. 25 shows the current gear speed deceleration, the speed target deceleration, the maximum target deceleration, the speed of the automatic transmission 10, the rotation speed of the input shaft of the automatic transmission 10 (AT), the torque of the output shaft of the AT, the braking force, and the accelerator opening amount. At time T0, the current deceleration (i.e., the actual deceleration of the vehicle) is the same as the current gear speed deceleration, shown by reference numeral 303.

First in step S1 in FIG. 18A, the control circuit 130 determines whether the distance between the host vehicle and the preceding vehicle is equal to, or less than, a predetermined value based on a signal indicative of the vehicle-to-vehicle distance input from the vehicle-to-vehicle distance measuring portion 100a. If it is determined that the vehicle-to-vehicle distance is equal to, or less than, the predetermined value, then step S2 is executed. If, on the other hand, it is determined that the vehicle-to-vehicle distance is not equal to, nor less than, the predetermined value, the control flow ends.

Instead of directly determining whether the vehicle-to-vehicle distance is equal to, or less than, the predetermined value, the control circuit 130 may also indirectly determine whether the vehicle-to-vehicle distance is equal to, or less than, the predetermined value by a parameter by which it can be known that the vehicle-to-vehicle distance is equal to, or less than, the predetermined value, such as the time to collision (vehicle-to-vehicle distance/relative vehicle speed), the time between vehicles (vehicle-to-vehicle distance/host vehicle speed), or a combination of the two.

In step S2, the control circuit 130 determines whether the accelerator is off based on a signal output from the throttle opening amount sensor 114. If it is determined in step S2 that the accelerator is off, then step S3 is executed. Vehicle-following control starts from step S3. If, on the other hand, it is determined that the accelerator is not off, the control flow ends.

In step S3, the control circuit 130 obtains a target deceleration. The target deceleration is obtained as a value (deceleration) with which the relationship with the preceding vehicle comes to equal the target vehicle-to-vehicle distance or relative vehicle speed when deceleration control based on that target deceleration (to be described later) is executed in the host vehicle.

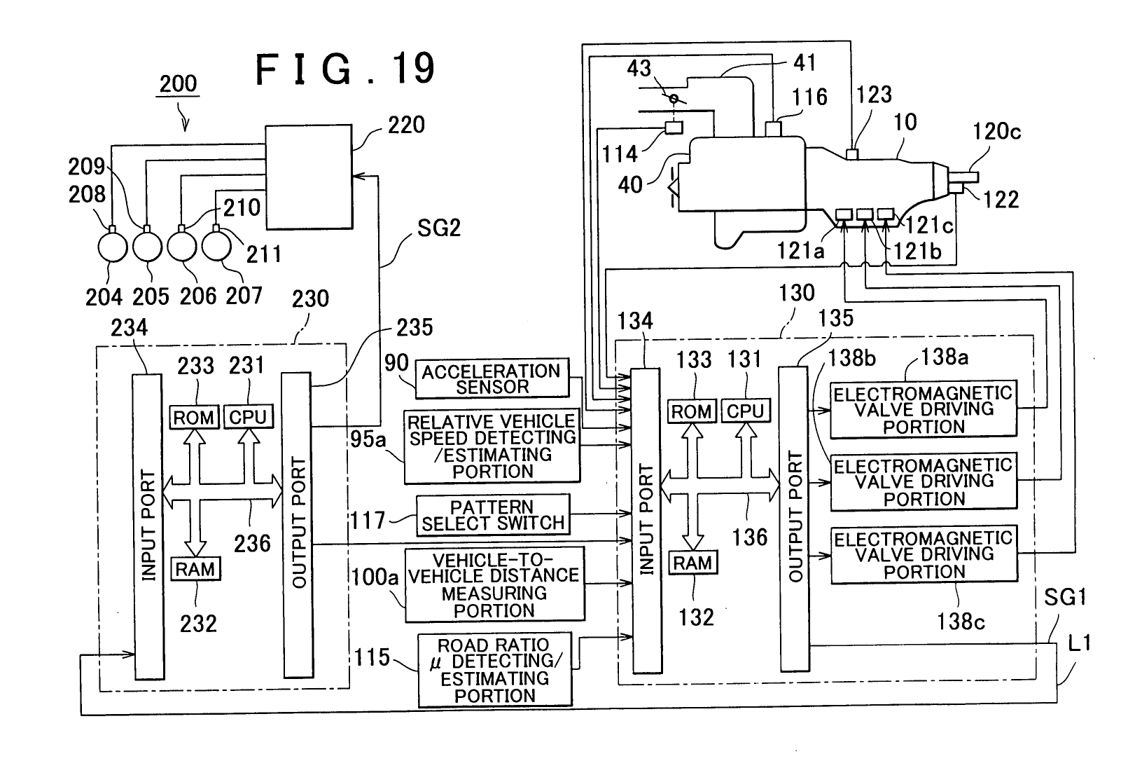

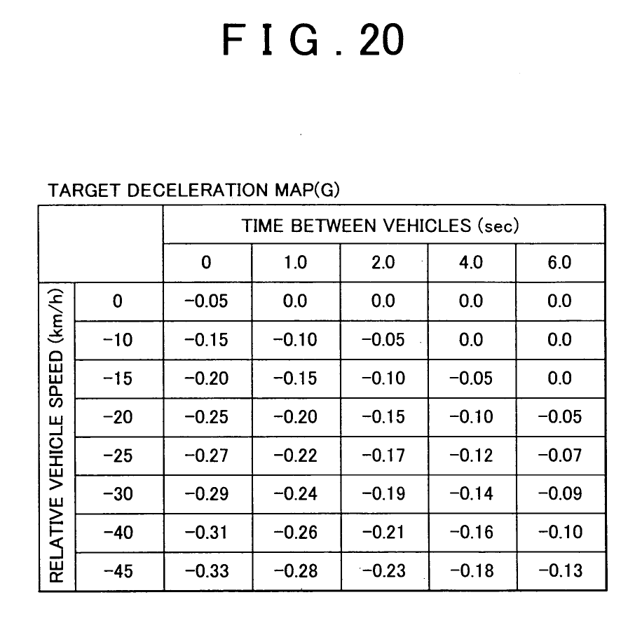

The target deceleration is obtained referencing a target deceleration map (FIG. 20) stored in the ROM 133 beforehand. As shown in FIG. 20, the target deceleration is obtained based on the relative speed (km/h) and time (sec) between the host vehicle and the preceding vehicle. Here, the time between vehicles is the vehicle-to-vehicle distance divided by the host vehicle speed, as described above.

In FIG. 20, for example, when the relative vehicle speed (here the relative vehicle speed equals the preceding vehicle speed minus the host vehicle speed) is −20 [km/h] and the time between the vehicles is 1.0 [sec], the target deceleration is −0.20 (G). The absolute value of the target deceleration is set smaller (so that the vehicle will not decelerate) the closer the relationship between the host vehicle and the preceding vehicle is to a safe relative vehicle speed and vehicle-to-vehicle distance. That is, the target deceleration is obtained as a value that has a smaller absolute value on the upper right side of the target deceleration map in FIG. 20 the greater the distance between the host vehicle and the preceding vehicle. On the other hand, the target deceleration is obtained as a value that has a larger absolute value on the lower left side of the target deceleration map in FIG. 20 the closer the distance between the host vehicle and the preceding vehicle.

The target deceleration obtained in step S3 is referred to as the target deceleration, or more specifically, the maximum target deceleration, for before the shift control (step S7) and the brake control (step S8) are actually performed (i.e., at the starting point of the deceleration control) after the conditions to start the deceleration control (steps S1 and S2) have been satisfied. That is, because the target deceleration is set in real time even while the deceleration control is being executed, as will be described later, the target deceleration obtained in step S3 is referred to specifically as the maximum target deceleration in order to differentiate it from the target deceleration set after the brake control and shift control have actually been executed (i.e., while the brake control and shift control are being executed). After step S3, step S4 is executed.

In step S4, the target deceleration is set. Here, the target deceleration is set to reach the maximum target deceleration at a predetermined gradient from the current (when the control starts; time T0 in FIG. 25) deceleration 303 (i.e., the current gear speed deceleration). The predetermined gradient can be changed based on the road ratio μ, the accelerator return rate at the start of the control, or the opening amount of the accelerator before it is returned. For example, the gradient (slope) is set small when the road ratio μ is small and large when the accelerator return rate or the opening amount of the accelerator before it is returned is large. In the example in FIG. 25, the target deceleration reaches the maximum target deceleration at time T1 as a result of the target deceleration being set based on the predetermined gradient. The signal indicative of that set target deceleration is output as the brake braking force signal SG1 from the control circuit 130 to the brake control circuit 230 via the brake braking force signal line L1. Here, the set target deceleration is the overall target deceleration of the cooperative control of the brake system 200 and the automatic transmission 10.

In step S5, the control circuit 130 obtains the target deceleration produced by the automatic transmission 10 (hereinafter referred to as “speed target deceleration”), and then determines the speed to be selected for the shift control (downshift) of the automatic transmission 10 based on the speed target deceleration. Here, the speed to be selected that is determined corresponds to the speed selected as the speed appropriate for achieving the overall target deceleration of the cooperative control. The details of step S5 are described broken down into two parts ((1) and (2)) as follows.

(1) First, the speed target deceleration is obtained. The speed target deceleration corresponds to the engine braking force (deceleration) to be obtained by the shift control of the automatic transmission 10. The speed target deceleration is set to be a value equal to, or less than, the maximum target deceleration. (Note: the degree of deceleration referred to here and throughout this specification refers to the size of the absolute value of the deceleration.) The speed target deceleration can be obtained by any of the following three methods.

The first of the three methods for obtaining the speed target deceleration is as follows. The speed target deceleration is set in step S3 as the product of a coefficient greater than 0 but equal to, or less than, 1 multiplied by the maximum target deceleration obtained from the target deceleration map in FIG. 20. For example, when the maximum target deceleration is −0.20 G, as in the case of the example in step S3, the speed target deceleration can be set to −0.10 G, which is the product of the maximum target deceleration −0.20 G multiplied by the coefficient 0.5, for example.

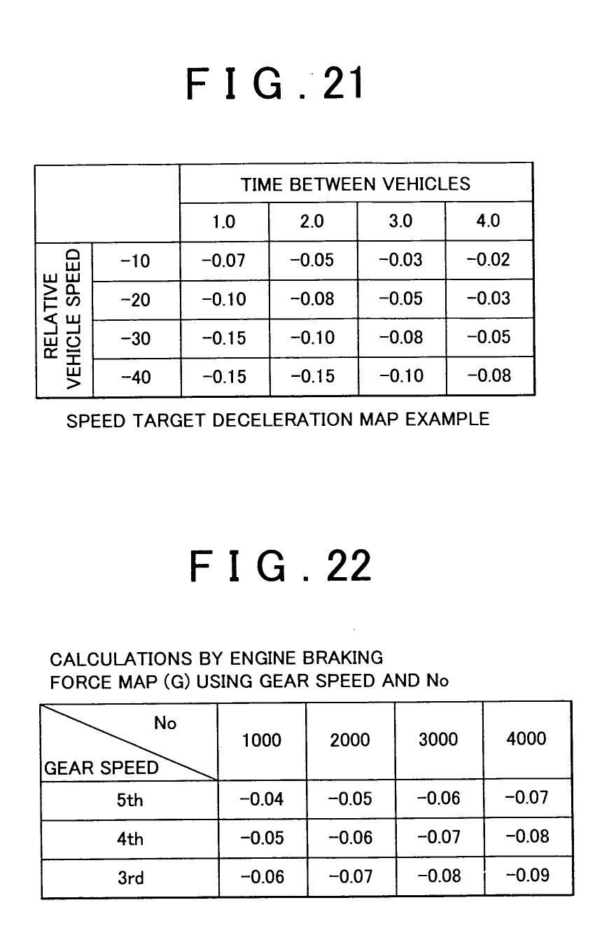

The second of the three methods for obtaining the speed target deceleration is as follows. A speed target deceleration map (FIG. 21) is stored in the ROM 133 in advance. The speed target deceleration can then be obtained referencing this speed target deceleration map in FIG. 21. As shown in FIG. 21, the speed target deceleration can be obtained based on the relative vehicle speed [km/h] and time [sec] between the host vehicle and the preceding vehicle, just like the target deceleration in FIG. 20. For example, if the relative vehicle speed is −20 [km/h] and the time between vehicles is 1.0 [sec], as in the case of the example in step S3, a speed target deceleration of −0.10 G can be obtained. As is evident from FIGS. 20 and 21, when i) the relative vehicle speed is high so that the vehicles suddenly come close to one another, ii) the time between vehicles is short, or iii) the vehicle-to-vehicle distance is short, the vehicle-to-vehicle distance must be appropriately established early on, so the deceleration must be made larger. This also results in a lower speed being selected in the above-described situation.

The third of the three methods for obtaining the speed target deceleration is as follows. First, the engine braking force (deceleration G) when the accelerator is off in the current gear speed of the automatic transmission 10 is obtained (hereinafter simply referred to as the “current gear speed deceleration”). A current gear speed deceleration map (FIG. 22) is stored in advance in the ROM 133. The current gear speed deceleration (deceleration) can be obtained referencing this current gear speed deceleration map in FIG. 22. As shown in FIG. 22, the current gear speed deceleration can be obtained based on the gear speed and the rotation speed No of the output shaft 120c of the automatic transmission 10. For example, when the current gear speed is 5th speed and the output rotation speed is 1000 [rpm], the current gear speed deceleration is −0.04 G.

The current gear speed deceleration may also be a value obtained from the current gear speed deceleration map, which is corrected according to the situation, for example, according to whether an air conditioner of the vehicle is being operated, whether there is a fuel cut, and the like. Further, a plurality of current gear speed deceleration maps, one for each situation, may be provided in the ROM 133, and the current gear speed deceleration map used may be switched according to the situation.

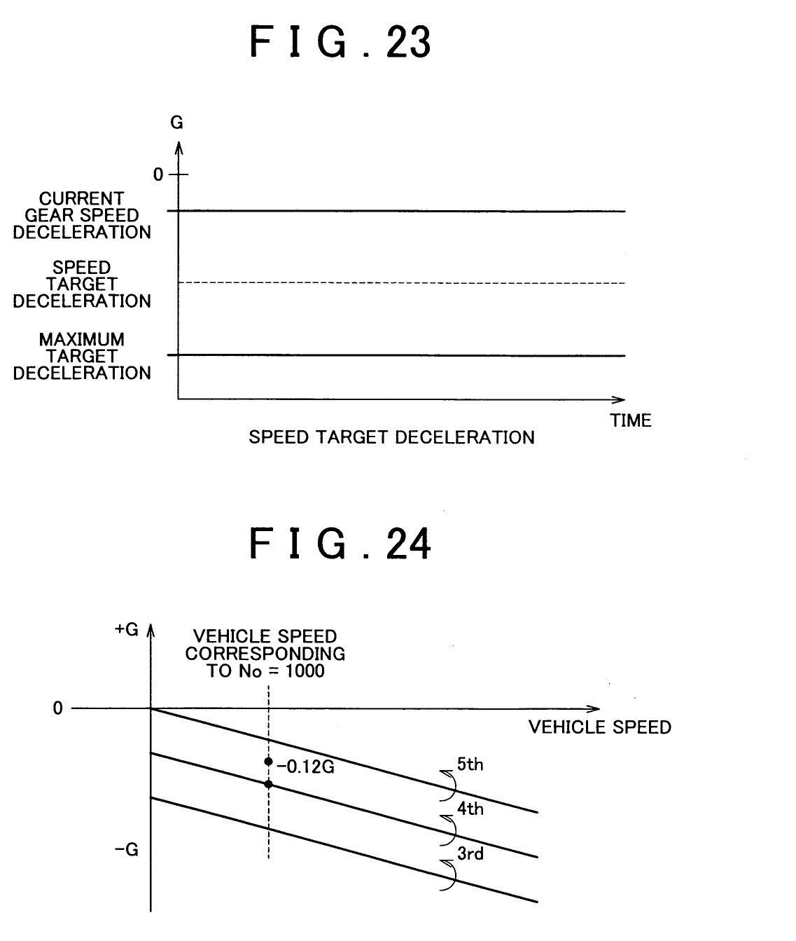

Next, the speed target deceleration is set as a value between the current gear speed deceleration and the maximum target deceleration. That is, the speed target deceleration is obtained as a value that is larger than the current gear speed deceleration but equal to, or less than, the maximum target deceleration. One example of the relationship between the speed target deceleration, the current gear speed deceleration, and the maximum target deceleration is shown in FIG. 23.

The speed target deceleration can be obtained by the following expression.
speed target deceleration=(maximum target deceleration−current gear speed deceleration)×coefficient+current gear speed deceleration
In the above expression, the coefficient is a value greater than 0 but equal to, or less than, 1.

In the above example, the maximum target deceleration is −0.20 G and the current gear speed deceleration is −0.04 G. When calculated with a coefficient of 0.5, the speed target deceleration is −0.12 G.

As described above, in the first through third methods for obtaining the speed target deceleration, a coefficient is used. The value of this coefficient, however, is not obtained theoretically, but is a suitable value that is able to be set appropriately from the various conditions. That is, in a sports car, for example, a relatively large deceleration is preferable when decelerating, so the coefficient can be set to a large value. Also, in the same vehicle, the value of the coefficient can be variably controlled according to the vehicle speed or the gear speed. In a vehicle in which a sport mode (which aims to increase the vehicle response to an operation by the driver so as to achieve crisp and precise handling), a luxury mode (which aims to achieve a relaxed and easy response to an operation by the driver), and an economy mode (which aims to achieve fuel efficient running) are available, when the sport mode is selected, the speed target deceleration is set so that a larger speed change occurs than would occur in the luxury mode or the economy mode.

After being obtained in step S5, the speed target deceleration is not reset until the deceleration control ends. That is, the speed target deceleration is set so that, once it is obtained at the starting point of the deceleration control (i.e., the point at which the brake control (step S8) and the shift control (step S7) actually start), it is the same value until the deceleration control ends. As shown in FIG. 23, the speed target deceleration (the value shown by the broken line) is a constant value over time.

(2) Next, the speed to be selected during the shift control of the automatic transmission 10 is determined based on the speed target deceleration obtained in part (1) above. Vehicle characteristic data indicative of the deceleration G at each speed in each gear speed when the accelerator is off, such as that shown in FIG. 24, is stored in advance in the ROM 133.

Here, assuming a case in which the output rotation speed is 1000 [rpm] and the speed target deceleration is −0.12 G, just as in the example given above, the gear speed corresponding to the vehicle speed when the output speed is 1000 [rpm] and the deceleration is closest to the speed target deceleration of −0.12 G is 4th speed, as can be seen in FIG. 24. Accordingly, in the case of the above example, it would be determined in step S5 that the gear speed to be selected is 4th speed.

Here, the gear speed that would achieve a deceleration closest to the speed target deceleration is selected as the gear speed to be selected. Alternatively, however, the gear speed to be selected may be a gear speed that would achieve a deceleration which is both equal to, or less than, (or equal to, or greater than,) the speed target deceleration, and closest to the speed target deceleration. After step S5, step S6 is executed.

In step S6, the control circuit 130 determines whether the accelerator and the brake are off. In step S6, when the brake is off, it means that the brake is off because a brake pedal (not shown) is not being operated by the driver. This determination is made based on output from a brake sensor (not shown) that is input via the brake control circuit 230. If it is determined in step S6 that both the accelerator and the brake are off, step S7 is executed. If, on the other hand, it is not determined that both the accelerator and the brake are off, step S12 is executed.

At time T0 in FIG. 25, the brake is off (i.e., braking force equals zero), as shown by reference numeral 302, and the accelerator is off (i.e., the accelerator opening amount is zero with the accelerator being fully closed), as shown by reference numeral 301.

In step S7, the control circuit 130 starts the shift control. That is, automatic transmission 10 is shifted to the selected gear speed (4th speed in this example) that was determined in step S5. The automatic transmission 10 is downshifted by the shift control at time T0 in FIG. 25, as shown by reference numeral 304. As a result, the engine braking force increases, so the current deceleration 303 increases a corresponding amount. After step S7, step S8 is executed.

In step S8, the brake control circuit 230 starts the brake control. That is, the brakes are feedback controlled so that the current deceleration 303 matches the target deceleration set in step S4. As a result of that feedback control, the braking force 302 gradually increases from time T0 to time T1 in FIG. 25, causing the current deceleration 303 to increase following the target deceleration. The brake feedback control is continued until the current deceleration 303 reaches the end-point deceleration (the maximum target deceleration, in this case) of the set target deceleration at time T1 (step S9).

In step S7, the brake control circuit 230 outputs the brake control signal SG2 to the hydraulic pressure control circuit 220 based on the brake braking force signal SG1 input from the control circuit 130. As described above, the hydraulic pressure control circuit 220 generates the braking force 302 as indicated by the brake control signal SG2 by controlling the hydraulic pressure supplied to the brake devices 208, 209, 210, and 211 based on the brake control signal SG2.

The braking force 302 by the brake control may also be determined taking into account a time differential value of the rotation speed of the input shaft of the automatic transmission 10 and a shift inertia torque amount determined by the inertia.

Here, both the target deceleration set in step S4 and the target deceleration set again in step S10, which will be described later, are included in the “target deceleration” in steps S8 and S9. The brake control of step S8 continues to be executed until it is ended in step S12. After step S8, step S9 is executed.

In step S9, the control circuit 130 determines whether the current deceleration 303 is the end-point deceleration of the set target deceleration. If it is determined that the current deceleration 303 is the end-point deceleration of the set target deceleration, then step S10 is executed. If, on the other hand, it is determined that the current deceleration 303 is not the end-point deceleration of the set target deceleration, the process returns to step S8. Because the current deceleration 303 does not reach the end-point deceleration of the set target deceleration (here, the maximum target deceleration) until time T1 in FIG. 25, the feedback control of the brake is continued in step S8 until it does.

Then in step S10, the target deceleration is set again, as shown in FIG. 18B. The control circuit 130 sets the target deceleration referencing the target deceleration map (FIG. 20), just as in step S3. The target deceleration is set based on the relative vehicle speed and the vehicle-to-vehicle distance, as described above. Because the relative vehicle speed and the vehicle-to-vehicle distance change when the deceleration control (i.e., both the shift control and the brake control) starts, the target deceleration is set in real time according to that change.

When the target deceleration is set in real time in step S10, the braking force 302 is applied to the vehicle such that the current deceleration 303 matches the target deceleration by the brake feedback control that is continuing from when it was started in step S8 (see steps S7 and S8).

The operation to obtain the target deceleration in step S10 continues to be performed until the brake control ends in step S12. The brake control continues (steps S11 and S12) until the current deceleration 303 matches the speed target deceleration, as will be described later. Because the current deceleration 303 is controlled to match the target deceleration (steps S8 and S9), as described above, the operation to set the target deceleration in step S10 continues until the set target deceleration matches the speed target deceleration.

At the time that step S10 is executed, the vehicle speed of the host vehicle is less, by the amount that the deceleration control has already been performed, than it was at the time that step S3 was performed before the start of the deceleration control. From this, the target deceleration set in order to achieve the target vehicle-to-vehicle distance and relative vehicle speed usually becomes, in step S10, a value smaller than the maximum target deceleration obtained in step S3.

From time T1 to time T7 in FIG. 25, the operation of setting the target deceleration in real time and applying the braking force 302 such that the current deceleration 303 matches that target deceleration is repeated. During that time, however, as a result of the brake control being continued, the target deceleration repeatedly set in step S10 gradually decreases. In response to this decrease in the value of the target deceleration, the braking force 302 applied by the feedback control of the brake control also gradually decreases, such that the current deceleration 303 gradually decreases while substantially matching that target deceleration. After step S10, step S11 is executed.

In step S11, the control circuit 130 determines whether the current deceleration 303 matches the speed target deceleration. If it is determined that the current deceleration 303 matches the speed target deceleration, the brake control ends (step S12) and this fact is transmitted to the brake control circuit 230 by the brake braking force signal SG1. If, on the other hand, the current deceleration 303 does not match the speed target deceleration, the brake control does not end. Since the current deceleration 303 matches the speed target deceleration at time T7 in FIG. 25, the braking force 302 applied to the vehicle becomes zero (i.e., the brake feedback control ends).

In step S13, the control circuit 130 determines whether the accelerator is on. If the accelerator is on, step S14 is executed. If not, step S17 is executed. In the example in FIG. 25, it is determined that the accelerator is on at time t8.

In step S14, a return timer is started. In the example in FIG. 25, the return timer starts from time T8. After step S14, step S15 is executed. The return timer (not shown) is provided in the CPU 131 of the control circuit 130.

In step S15, the control circuit 130 determines whether a count value of the return timer is equal to, or greater than, a predetermined value. If the count value is not equal to, nor greater than, the predetermined value, the process returns to step S13. If the count value is equal to, or greater than, the process proceeds on to step S16. In the example shown in FIG. 25, the count value becomes equal to, or greater than, the predetermined value at time T9.

In step S16, the control circuit 130 ends the shift control (downshift control) and returns the automatic transmission 10 to the speed determined based on the accelerator opening amount and the vehicle speed according to a normal shift map (shift line) stored beforehand in the ROM 133. In the example shown in FIG. 25, the shift control ends at time T9, at which time an upshift is executed. When step S16 is executed, the control flow ends.

In step S17, the control circuit 130 determines whether the vehicle-to-vehicle distance exceeds a predetermined value. Step S17 corresponds to step S1. If it is determined that the vehicle-to-vehicle distance does exceed the predetermined value, step S16 is then executed. If it is determined that the vehicle-to-vehicle distance does not exceed the predetermined value, the process returns to step S13.

The foregoing exemplary embodiment enables the following effects to be achieved. According to this exemplary embodiment, the deceleration necessary for the vehicle-to-vehicle distance control is set as the overall target deceleration of the cooperative control, and the brakes, which have good response, are feedback controlled to achieve that set target deceleration. Therefore, the current deceleration is able to accurately follow the overall target deceleration (i.e., the deceleration necessary for the vehicle-to-vehicle distance control) of the cooperative control. As a result, vehicle-following control (i.e., vehicle-to-vehicle distance control) with respect to the distance between vehicles which changes continuously is able to be performed smoothly.

According to this exemplary embodiment, the speed target deceleration is set so as to be between the current gear speed deceleration and the maximum target deceleration (step S4). That is, the deceleration caused by the engine braking force obtained from the downshift (shift control) into the selected gear speed is set so as to be between the engine braking force of the speed before the start of the deceleration control (i.e., the current gear speed deceleration) and the maximum target deceleration (step S5). As a result, even when deceleration control in which the brake control and shift control are performed simultaneously in cooperation with one another is executed (steps S7 and S8), the deceleration is not excessive so no sense of discomfort is imparted to the driver. In addition, even when the vehicle-to-vehicle distance and the relative vehicle speed have reached their respective target values and the brake control has ended (step S12), the engine brake from the downshift continues to be effective so hunting of the brake control due to an increase in vehicle speed (particularly when on a downward slope) following the end of the brake control (step S12) is able to be effectively suppressed.

Also according to this exemplary embodiment, from time T1 to time T7 in FIG. 25 after the current deceleration 303 matches the maximum target deceleration (step S9), the current deceleration 303 gradually decreases while substantially matching the target deceleration calculated in real time. Then at the point when the target deceleration (the same as the current deceleration 303 in this case) matches the speed target deceleration, the brake control ends, as shown in steps S11 and S12. That is, the brake control ends when the target deceleration calculated in real time matches the speed target deceleration (i.e., the deceleration after the downshift control). In other words, the brake control does not continue until the target deceleration (the current deceleration 303 in this case) returns to the deceleration that it was at time T0 when the deceleration control started (i.e., returns to the current gear speed deceleration).

If the deceleration control were to be performed by the brake control alone, i.e., without performing the shift control, it would be necessary to continue the brake control until the target deceleration returned to near the current gear speed deceleration and the target vehicle-to-vehicle distance and relative vehicle speed could be realized by the current gear speed deceleration alone. In contrast, because in this exemplary embodiment the shift control and the brake control are performed simultaneously in cooperation with one another, the brake control can be ended when the target deceleration substantially matches the deceleration achieved by the shift control (i.e., the speed target deceleration) and the target vehicle-to-vehicle distance and relative vehicle speed can be achieved by the deceleration achieved by the shift control alone. As a result, in this exemplary embodiment, the brake control can be ended in a shorter period of time, which ensures durability of the brakes (i.e., reduces brake fade and wear on the brake pads and discs.

Further in this exemplary embodiment, the brake control ends when the target deceleration (i.e., the current deceleration 303 in this case) matches the speed target deceleration (i.e., the deceleration after the downshift control), and deceleration control by only the shift control is performed from that point (steps S11 and S12; time T7 in FIG. 25). As a result, deceleration control is performed with only shift control while the current deceleration 303 substantially matches the deceleration after the shift control (i.e., the deceleration produced by the engine braking force), which enables a smooth transition to the deceleration produced by the engine braking force.

As described above, the brake control ends when the target deceleration substantially matches the speed target deceleration (i.e., the deceleration produced by the engine braking force after the shift control). The shift control, on the other hand, ends either after a predetermined period of time has passed after the accelerator has been turned on (steps S13 and S14) after the brake control ends (step S12) or when the vehicle-to-vehicle distance exceeds a predetermined value after the brake control ends (step S17). In this way, by making the conditions for ending (i.e., returning from) the brake control different from those for ending (i.e., returning from) the shift control, the brake control can be ended in a short period of time, thus helping to ensure durability of the brakes. Also, because the shift control does not end unless the vehicle-to-vehicle distance exceeds the predetermined value, the engine brake continues to be effective.

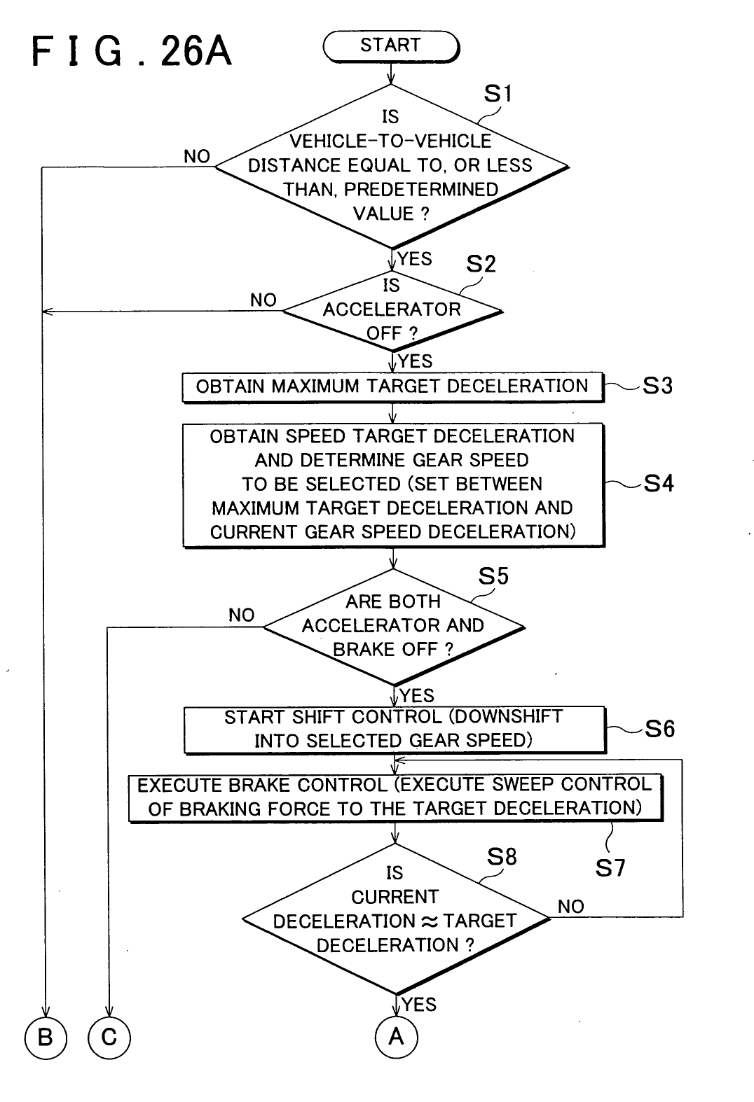

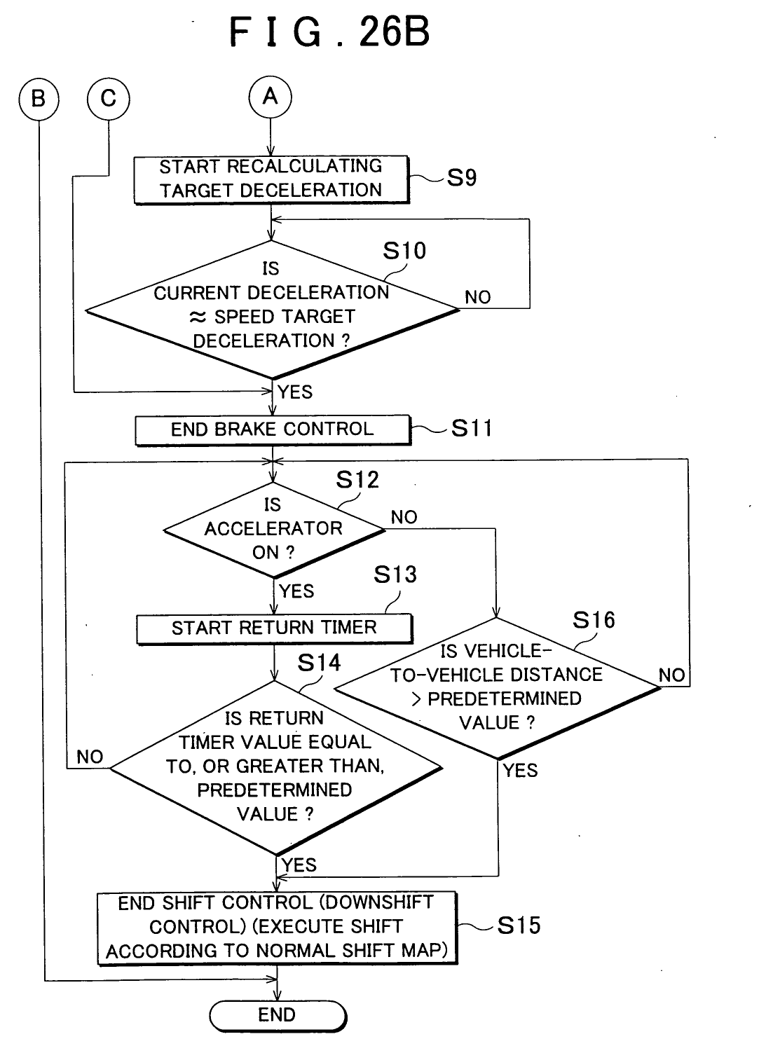

Next, a seventh exemplary embodiment of the invention will be described with reference to FIGS. 26A and 26B and FIG. 25. Descriptions of parts in the seventh exemplary embodiment that are the same as those in the sixth exemplary embodiment will be omitted; only parts that are different will be described.

In the sixth exemplary embodiment, feedback control is performed. In contrast, in the seventh exemplary embodiment, the brake control is performed on the brake as follows. That is, the brake is controlled to compensate for the insufficiency in the deceleration 402 produced by the shift of the automatic transmission 10 (i.e., by the downshift into the selected gear speed) so that the braking force 12 increases by a predetermined gradient until the deceleration that acts on the vehicle reaches the target deceleration.

FIGS. 26A and 26B show the control flow of the seventh exemplary embodiment of the invention. FIG. 25 is a time chart of the seventh exemplary embodiment (the same as in the sixth exemplary embodiment). As can be seen from FIGS. 26A, 26B, and 25, much of the seventh exemplary embodiment is the same as the sixth exemplary embodiment described above. Therefore, only parts that are different will be described here.

Step S4 (setting the target deceleration at a predetermined gradient) in FIG. 18A is omitted in FIG. 26A, as can be seen when comparing FIG. 26A with FIG. 18A which shows the flow of the sixth exemplary embodiment. In the seventh exemplary embodiment, only the maximum target deceleration is set for the target deceleration in step S3 until before the brake control starts (step S7). Steps S1 to S6 in FIG. 26A are the same as steps S1 to S3 and S5 to S7 in FIG. 18A, so descriptions thereof will be omitted here.

In step S7, the brake control circuit 230 starts the brake control. That is, the braking force is gradually increased (sweep control) at a predetermined gradient until the target deceleration. From time T0 to time T1 in FIG. 25, the braking force 302 increases at a predetermined gradient, which results in an increase in the current deceleration 303. The braking force 302 continues to increase until the current deceleration 303 reaches the target deceleration at time T1 (step S8).

Just as in the sixth exemplary embodiment, the brake control circuit 230 outputs the brake control signal SG2 to the hydraulic pressure control circuit 220 based on the brake braking force signal SG1 input from the control circuit control circuit 130.

The predetermined gradient in step S7 is determined by the brake braking force signal SG1 which is referenced when generating the brake control signal SG2. The predetermined gradient is indicated by the brake braking force signal SG1 and can be changed based on the road ratio μ, the accelerator return rate at the start of the control (immediately before time T0 in FIG. 25), or the opening amount of the accelerator before it is returned. For example, the gradient (slope) is set small when the road ratio μ is small and large when the accelerator return rate or the opening amount of the accelerator before it is returned is large.

The braking force 302 by the brake control may be determined taking into account a time differential value of the rotation speed of the input shaft of the automatic transmission 10 and a shift inertia torque amount determined by the inertia.

Here, both the maximum target deceleration obtained in step S3 and the target deceleration obtained again in step S9, which will be described later, are included in the “target deceleration” in step S7. The brake control of step S7 continues to be executed until it is ended in step S11. After step S7, step S8 is executed.

In step S8, the control circuit 130 determines whether the current deceleration 303 is the target deceleration. If it is determined that the current deceleration 303 is the target deceleration, step S9 is executed. If, on the other hand, it is determined that the current deceleration 303 is not the target deceleration, the process returns to step S7. Because the current deceleration 303 does not reach the target deceleration until time T1 in FIG. 25, the braking force 302 increases at a predetermined gradient in step S7 until then.

Because steps S9 to S15 in FIG. 26B are the same as steps S10 to S16 in FIG. 18B, a described thereof will be omitted.

Just like the exemplary embodiments described above, the seventh exemplary embodiment also uses the brake, which has superior response and controllability, to compensate for the shortage of deceleration produced by the shift of the automatic transmission 10 so that, as an overall result of the cooperative control, the target deceleration is produced.

According to the seventh exemplary embodiment, it is possible to stop (temporarily and with good response) the braking force 12 from being applied to the vehicle (time T1) when the maximum target deceleration is produced as an overall result of the cooperative control due to the braking force 12 being applied to the vehicle. Accordingly, a deceleration exceeding the maximum target deceleration as an overall result of the cooperative control, whether temporary or not, which acts on the vehicle (i.e., overshooting) is able to be minimized.

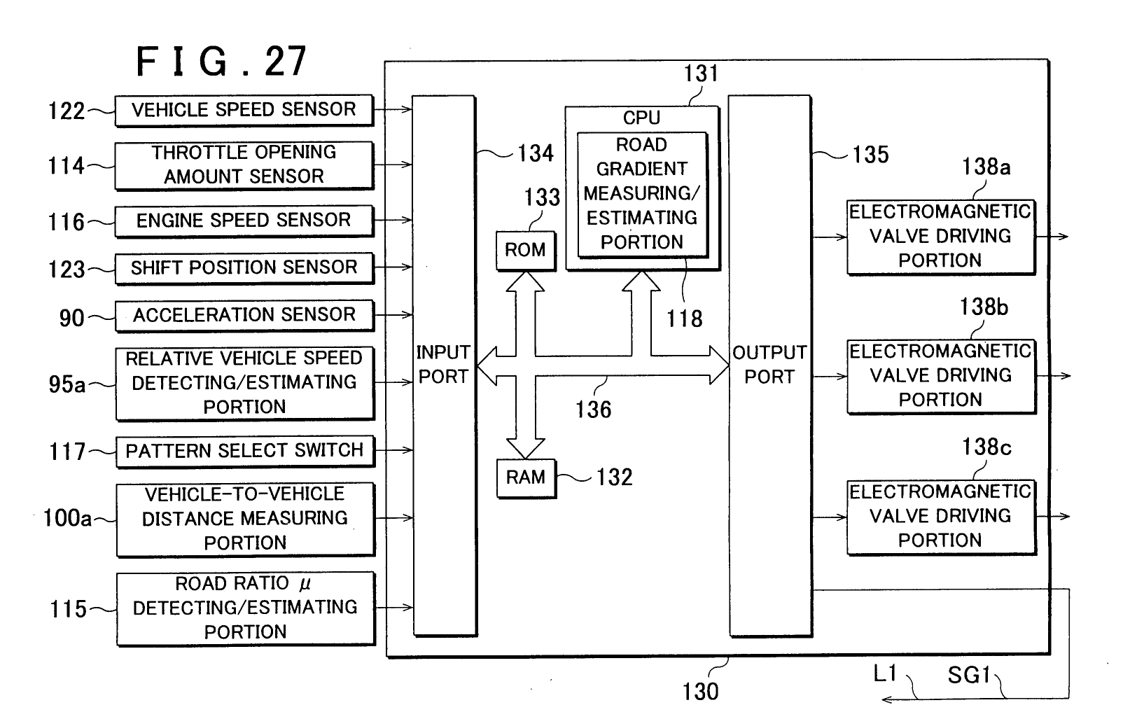

Next, an eighth exemplary embodiment of the invention will be described with reference to FIG. 27. Descriptions of parts in the eighth exemplary embodiment that are the same as those in the sixth and seventh exemplary embodiments will be omitted; only parts that are different will be described.

The eighth exemplary embodiment relates to the speed target deceleration of the sixth and seventh exemplary embodiments (step S5 or step S4). In the eighth exemplary embodiment, the speed target deceleration is corrected according to the gradient of the road. FIG. 27 is a block diagram schematically showing the control circuit 130 according to the eighth exemplary embodiment. In the eighth exemplary embodiment, a road gradient measuring/estimating portion 118 is provided which measures or estimates the road gradient.

The road gradient measuring/estimating portion 118 can be provided as a portion of the CPU 131. The road gradient measuring/estimating portion 118 can measure or estimate the road gradient based on acceleration detected by the acceleration sensor 90. Further, the road gradient measuring/estimating portion 118 can store acceleration on a level road in the ROM 133 in advance, and obtain the road gradient by comparing that stored acceleration with the actual acceleration detected by the acceleration sensor 90.

In this exemplary embodiment, the speed target deceleration is corrected as follows. First, a gradient correction quantity (deceleration) is obtained. Here, it is obtained as a gradient 1%≈0.01 G (an upward gradient is positive and a downward gradient is negative).

Next, the speed target deceleration after the correction can be obtained from the following expression according to the third method for obtaining the speed target deceleration.
speed target deceleration=(maximum target deceleration−current gear speed deceleration)×coefficient+current gear speed deceleration+gradient correction quantity
In the above expression, the coefficient is a value that is greater than 0 but equal to, or less than, 1.

Accordingly, on a downward gradient such as a downward slope, the speed target deceleration is corrected to a large value such that the gear speed to be selected, which is determined in step S5 or step S4, is a lower gear speed than a gear speed selected when on a level road. On an upward gradient, the speed target deceleration is corrected to a small value such that the gear speed to be selected, which is determined in step S5 or step S4, is a higher gear speed than a gear speed selected when on a level road.

According to the eighth exemplary embodiment, correcting the speed target deceleration according to the gradient of the road on which the vehicle is traveling enables optimum engine braking force to be obtained. As a result, an engine braking amount which matches that expected by the driver (i.e., required by the driver) is able to be obtained.

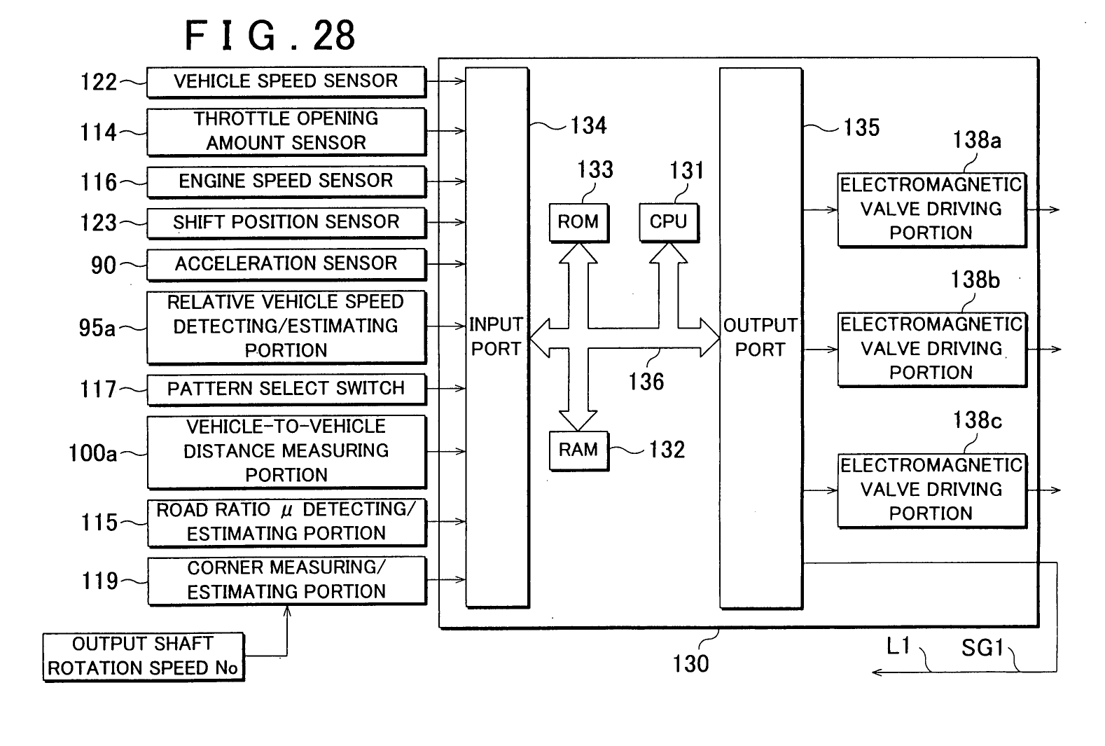

Next, a ninth exemplary embodiment of the invention will be described with reference to FIG. 28. Descriptions of parts in the ninth exemplary embodiment that are the same as those in the foregoing exemplary embodiments will be omitted; only parts that are different will be described.

The ninth exemplary embodiment relates to the speed target deceleration (step S5 or step S4) of the sixth or seventh exemplary embodiment, just like the eighth exemplary embodiment. The ninth exemplary embodiment corrects the speed target deceleration according to the shape of the road, such as the size (radius) of an upcoming corner, or any intersections or junctions that might be ahead. One example of a correction according to the size of a corner is as follows. FIG. 28 is a block view schematically showing the control circuit 130 according to the ninth exemplary embodiment. In the ninth exemplary embodiment, a corner measuring/estimating portion 119 which measures or estimates the size of a corner is connected to the control circuit 130.

The corner measuring/estimating portion 119 determines whether there is a corner ahead of the vehicle, and if so, measures or estimates the size of the corner. The determination and measurement or estimation are made based on, for example, information of the road shape obtained from a car navigation system mounted in the vehicle and an image captured by a camera mounted to the front of the vehicle. In the following example, the corner measuring/estimating portion 119 stores (in advance) the sizes of corners classified into one of three classifications (i.e., gentle, medium, hairpin) based on information indicating the size of the corner obtained by the car navigation system.

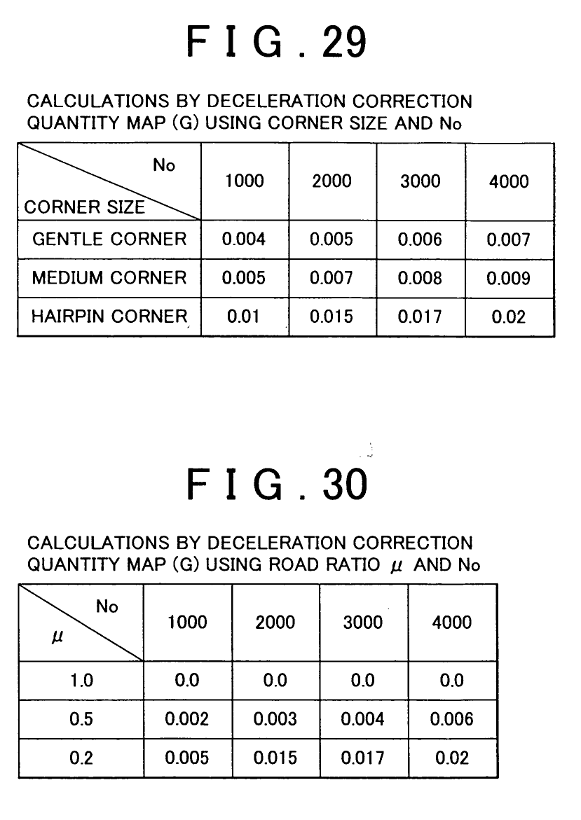

In this exemplary embodiment, the speed target deceleration is corrected as follows. First, a deceleration correction quantity (deceleration) for the corner is obtained. Here, a map such as that shown in FIG. 29, for example, which is stored in the corner measuring/estimating portion 119, may be used. Correction quantities for the deceleration are stored beforehand in the map. The correction quantities are based on the three different classifications of corner size and the rotation speed (No) of the output shaft 120c of the automatic transmission 10 corresponding to the vehicle speed.

For example, when a corner ahead of the vehicle is a medium corner and the current rotation speed of the output shaft 120c is 2000 [rpm], the deceleration correction quantity for that corner is obtained as 0.007 (G). The corner measuring/estimating portion 119 outputs data indicative of the deceleration correction quantity for that corner (hereinafter referred to as the “corner correction quantity”) to the control circuit 130.

Next, the speed target deceleration after the correction can be obtained from the following expression according to the third method for obtaining the speed target deceleration.
speed target deceleration=(maximum target deceleration−current gear speed deceleration)×coefficient+current gear speed deceleration−corner correction quantity
In the above expression, the coefficient is a value that is greater than 0 but equal to, or less than, 1.

Accordingly, on a sharp corner, the speed target deceleration is corrected to a considerably large value such that the gear speed to be selected, which is determined in step S5, is a much lower gear speed than a gear speed selected when on a straight road (i.e., not on a corner). On gentle curve, the amount of increase in the speed target deceleration is kept small compared to when on a sharp corner, such that the gear speed to be selected, which is determined in step S4, is a somewhat lower gear speed than a gear speed selected when on a straight road.

According to the ninth exemplary embodiment, correcting the speed target deceleration according to the shape, such as a corner, of the road on which the vehicle is traveling enables optimum engine braking force to be obtained. As a result, an engine braking amount which matches that expected by the driver (i.e., required by the driver) is able to be obtained.

Next, a tenth exemplary embodiment of the invention will be described with reference to FIG. 30. Descriptions of parts in the tenth exemplary embodiment that are the same as those in the foregoing exemplary embodiments will be omitted; only parts that are different will be described.

The tenth exemplary embodiment relates to the speed target deceleration (step S5 or step S4) of the sixth or seventh exemplary embodiment, just like the eighth and ninth exemplary embodiments. The tenth exemplary embodiment corrects the speed target deceleration based on the slipperiness of the road surface, such as the road ratio μ of the road on which the vehicle is traveling. The tenth exemplary embodiment uses the detection or estimation results from the road ratio μ detecting/estimating portion 115 that detects or estimates the road ratio μ.

The specific method for detecting or estimating the road ratio μ by the road ratio μ detecting/estimating portion 115 is not particularly limited, but can be any known method that is suitable. For example, other than the difference between the wheel speeds of the front and rear wheels, at least one of the change rate in the wheel speed, the operation history of ABS (antilock brake system), TRS (traction control system), or VSC (vehicle stability control), the acceleration of the vehicle, and navigation information can be used to detect/estimate the road ratio μ. Here, navigation information includes information pertaining to the road surface (such as whether the road is paved or not) stored on a storage medium (such as DVD or HDD) beforehand, as with a car navigation system, as well as information (including traffic and weather information) obtained by the vehicle itself through communication (including vehicle-to-vehicle communication and roadside-to-vehicle communication) with vehicles that were actually traveling earlier, other vehicles, or a communication center. This communication also includes road traffic information communication system (VICS) and so-called Telematics.

In this exemplary embodiment, the speed target deceleration is corrected as follows. First, a road ratio μ correction quantity (deceleration) is obtained. Here, a map such as that shown in FIG. 30, for example, which is stored in the ROM 133, may be used. Correction quantities for the deceleration are stored beforehand in the map. These correction quantities are based on the road ratio μ and the rotation speed (No) of the output shaft 120c of the automatic transmission 10 corresponding to the vehicle speed. For example, when the road ratio μ is 0.5 and the current rotation speed of the output shaft 120c is 2000 [rpm], the deceleration correction quantity (road ratio μ correction quantity) for that road ratio μ is obtained as 0.003 (G).

Next, the speed target deceleration after the correction can be obtained from the following expression according to the third method for obtaining the speed target deceleration.
speed target deceleration=(maximum target deceleration−current gear speed deceleration)×coefficient+current gear speed deceleration+road ratio μ correction quantity
In the above expression, the coefficient is a value that is greater than 0 but equal to, or less than, 1.

Accordingly, the speed target deceleration is corrected to a smaller value the lower the road ratio μ, such that the gear speed to be selected, which is determined in step S5 or step S4, is a higher gear speed than a gear speed selected when the road ratio μ is high.

According to the tenth exemplary embodiment, correcting the speed target deceleration according to the slipperiness of the road surface, such as the road ratio A, of the road on which the vehicle is traveling enables optimum engine braking force to be obtained. As a result, an engine braking amount which matches that expected by the driver (i.e., required by the driver) is able to be obtained.

The deceleration control apparatus for a vehicle according to this exemplary embodiment thus incorporates the advantages of both control of a brake system that applies braking force to the vehicle and shift control that shifts an automatic transmission into a relatively low speed or speed ratio, when performing deceleration control on the vehicle.

Various modifications are also possible with the foregoing first through the tenth exemplary embodiments. For example, in the examples described above, brake control is used. Instead of brake control, however, regenerative control by a MG (motor/generator) apparatus provided in a power train system (as in the case of a hybrid system) can also be used. Further, in the example described above, a stepped automatic transmission 10 is used for the transmission. The invention may of course also be applied, however, to a CVT (continuously variable transmission). In this case, the terms “gear speed” and “speed” may be replaced with the term “speed ratio”, and the term “downshift” may be replaced with the term “CVT adjustment”. Moreover, in the above description, the deceleration (G) is used as the deceleration indicative of the amount of deceleration of the vehicle. Alternatively, however, the control may be performed based on the deceleration torque.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element are also within the spirit and scope of the invention.

1. A deceleration control apparatus for a vehicle provided with a brake system for generating braking force in the vehicle, and a transmission, comprising:
a controller that controls the brake system and the transmission such that a deceleration acting on the vehicle matches a target deceleration set as a deceleration to be applied to the vehicle by a brake operation of the brake system and a shift operation which shifts the transmission into a relatively low speed or speed ratio.

2. The deceleration control apparatus for a vehicle according to claim 1, wherein the controller performs feedback control in the brake system taking into account a change in the deceleration by the shift operation so that the deceleration acting on the vehicle matches the target deceleration.

3. The deceleration control apparatus for a vehicle according to claim 1, wherein the controller updates the target deceleration in real time while the control of the braking force by the brake system is being executed.

4. The deceleration control apparatus for a vehicle according to claim 1, wherein a condition to end the control of the brake system is set differently from a condition to end the shift operation.

5. The deceleration control apparatus for a vehicle according to claim 1, wherein the controller sets the target deceleration to change along a predetermined gradient.

6. A deceleration control apparatus for a vehicle provided with a brake system for generating braking force in the vehicle, and a transmission, comprising:
a controller that controls the braking force generated by the brake system so that a target deceleration acts on the vehicle, based on i) the target deceleration which is set as a deceleration to be applied to the vehicle by a brake operation of the brake system and a shift operation which shifts the transmission into a relatively low speed or speed ratio, and ii) a deceleration by the shift operation into a speed or speed ratio selected as a speed or speed ratio appropriate for achieving the target deceleration.

7. The deceleration control apparatus for a vehicle according to claim 6, wherein the controller performs feedback control in the brake system taking into account a change in the deceleration by the shift operation so that the deceleration acting on the vehicle matches the target deceleration.

8. The deceleration control apparatus for a vehicle according to claim 6, wherein the controller updates the target deceleration in real time while the control of the braking force by the brake system is being executed.

9. The deceleration control apparatus for a vehicle according to claim 6, wherein the controller sets the target deceleration and selects a speed or speed ratio appropriate for achieving the target deceleration by shift point control or vehicle-to-vehicle distance control.

10. The deceleration control apparatus for a vehicle according to claim 6, wherein a condition to end the control of the brake system is set differently from a condition to end the shift operation.

11. The deceleration control apparatus for a vehicle according to claim 6, wherein the controller sets the target deceleration to change along a predetermined gradient.

12. A deceleration control method for a vehicle provided with a brake system for generating braking force in the vehicle, and a transmission, comprising:
setting a target deceleration as a deceleration to be applied to the vehicle by a brake operation of the brake system and a shift operation which shifts the transmission into a relatively low speed or speed ratio; and
controlling the brake system and the transmission so that the deceleration acting on the vehicle matches the set target deceleration.

13. The deceleration control method for a vehicle according to claim 12, wherein feedback control is performed in the brake system taking into account a change in the deceleration by the shift operation so that the deceleration acting on the vehicle matches the target deceleration.

14. The deceleration control method for a vehicle according to claim 12, wherein the target deceleration is updated in real time while the control of the braking force by the brake system is being executed.

15. The deceleration control method for a vehicle according to claim 12, wherein a condition to end the control of the brake system is set differently from a condition to end the shift operation.

16. The deceleration control method for a vehicle according to claim 12, wherein the target deceleration is set to change along a predetermined gradient.

17. A deceleration control method for a vehicle provided with a brake system for generating braking force in the vehicle, and a transmission, comprising:
setting a target deceleration as a deceleration to be applied to the vehicle by a brake operation of the brake system and a shift operation which shifts the transmission into a relatively low speed or speed ratio; and
controlling a braking force generated by the brake system so that the target deceleration acts on the vehicle, based on i) the set target deceleration, and ii) a deceleration by the shift operation into a speed or speed ratio selected as a speed or speed ratio appropriate for achieving the target deceleration.

18. The deceleration control method for a vehicle according to claim 17, wherein feedback control is performed in the brake system taking into account a change in the deceleration by the shift operation so that the deceleration acting on the vehicle matches the target deceleration.

19. The deceleration control method for a vehicle according to claim 17, wherein the target deceleration is updated in real time while the control of the braking force by the brake system is being executed.

20. The deceleration control method for a vehicle according to claim 17, wherein the target deceleration is set and a speed or speed ratio appropriate for achieving the target deceleration selected by shift point control or vehicle-to-vehicle distance control.

21. The deceleration control method for a vehicle according to claim 17, wherein a condition to end the control of the brake system is set differently from a condition to end the shift operation.

22. The deceleration control method for a vehicle according to claim 17, wherein the target deceleration is set to change along a predetermined gradient.
